(19) United States
(12) Patent Application Publication
(10) Pub. No.: US 2025/0330945 A1
(43) Pub. Date: Oct. 23, 2025

(54) ASSOCIATION MECHANISM FOR POSITIONING USING MULTIPLE TERMINAL DEVICES

(71) Applicant: Telefonaktiebolaget LM Ericsson (publ), Stockholm (SE)

(72) Inventors: Ritesh SHREEVASTAV, Upplands Väsby (SE); Lu ZHANG, Beijing (CN); Iana SIOMINA, Täby (SE); Xiaolin JIANG, Linköping (SE)

(21) Appl. No.: 19/121,001

(22) PCT Filed: Oct. 10, 2023
(86) PCT No.: PCT/CN2023/123742

§ 371 Date: Apr. 14, 2025

(30) Foreign Application Priority Data
Oct. 20, 2022 (WO) PCT/CN2022/126431
Apr. 21, 2023 (WO) PCT/CN2023/089933

(51) Int. Cl. H04W 64/00; H04B 7/06; H04W 8/22; H04W 60/04

(52) U.S. Cl. CPC H04W 64/00; H04B 7/06968; H04W 8/22; H04W 60/04

(57) ABSTRACT

The present disclosure is related to a terminal device, network nodes, and methods for associating multiple terminal devices such that a target can be positioned by using the multiple terminal devices. A method at a first terminal device for positioning a target that is associated with multiple terminal devices comprising the first terminal device comprises: obtaining an association with at least one second terminal device from the multiple terminal devices other than the first terminal device; and using association data for positioning.

### CROSS-REFERENCE TO RELATED APPLICATION(S)

This application claims priority to the PCT International Application No. PCT/CN2022/126431, entitled “IMPROVED TARGET POSITIONING BY USING MULTIPLE TERMINAL DEVICES”, filed on Oct. 20, 2022 and the PCT International Application No. PCT/CN2023/089933, entitled “ASSOCIATION MECHANISM FOR POSITIONING USING MULTIPLE TERMINAL DEVICES”, filed on Apr. 21, 2023, which are incorporated herein by reference in their entireties.

### TECHNICAL FIELD

The present disclosure is related to the field of telecommunication, and in particular, to network nodes, a terminal device, and methods for associating multiple terminal devices such that a target can be positioned by using the multiple terminal devices.

### BACKGROUND

With the development of the electronic and telecommunication technologies, mobile devices, such as a mobile phone, a smart phone, a laptop, a tablet, a vehicle mounted device, becomes an important part of our daily lives. One of the key features provided by a mobile device is location-based service (LBS). Because of the popularities of social networks and the widespread usage of mobile devices, demands for LBS are increased in both indoor and outdoor environments.

Positioning could be done with or without utilizing cellular mobile communication networks (e.g., 4^{th} generation (4G) Long Term Evolution (LTE) or 5^{th} generation (5G) New Radio (NR) networks).

There are so many positioning schemes without utilizing cellular mobile communication networks (i.e., the third-party schemes), for example, the schemes may exploit some certain combinations of the following technologies: Wi-Fi fingerprinting, ZigBee/Bluetooth fingerprinting, geomagnetic fingerprinting, inertial navigation, Radio Frequency Identification (RFID), Ultra Wideband (UWB) communications, visible light communications, ultrasonic wave, infrared ray, map matching, etc.

For positioning schemes with utilizing cellular mobile communication networks (i.e., cellular-based positioning), several traditional positioning methods exist in the 4G standards and can be naturally applied to 5G networks. Here, below is a non-exhaustive list of technologies that vendors and operators have at the moment and are likely to investigate first for the positioning service.
Enhanced cell identification (E-CID): E-CID offers a range of measurements for positioning purposes: angle-of-arrival/departure (AoA/AoD), received signal strength with path-loss model (RSSPLM), timing advance type 1 (TADV1, essentially a round trip time) or type 2 (TADV2)
“Relative time difference” based positioning (or called ranging based positioning): Typically, this kind of methods include observed or uplink time difference of arrival (OTDoA or UTDoA), which are called Downlink TDoA (DL-TDoA) or Uplink TDOA (UL-TDOA) in 5G standards, respectively. These two methods are both multilateration techniques based on relative timing measurements (DL-TDOA is based on DL Reference Signal Time Difference (RSTD), and UL TDoA is based on UL Relative Time of Arrival (RTOA)). The RSTD is the time of arrivals (ToA) difference of RS received from one transmission point and another RS from another (reference) transmission point. A conventional method to estimate the ToA is to find the time delay at which the correlation between the RS and the received signal has its maximum.
Radio Frequency (RF) pattern matching (or called fingerprinting) which is often used for indoor positioning: This method needs a database of signal fingerprints associated with different geographic positions. Typically a fingerprint of a certain location is associated with at least a signal measurement, such as the received signal strength (RSS). The location of the positioned target is estimated by comparing online measurements with a set of training samples at known positions. There are some obvious drawbacks for this method, e.g., the fingerprint feature(s) of each location have to be measured prior to location estimation, the locations with similar fingerprint feature(s) may be hard to be distinguished, and a previously collected fingerprint might not remain accurate in dynamic environments.
Assisted Global Navigation Satellite System (A-GNSS) which is generally used for outdoor positioning: This method is used to significantly improve the startup performance of a global navigation satellite system (GNSS). Specifically, this method works by supplying the necessary information (e.g., almanac, ephemeris) to the user device via a cellular network instead of the slow satellite link, essentially helping the GNSS receiver achieve a faster time-to-first-fix. The reason why A-GNSS is not used for indoor positioning is that satellite signals would generally be lost in indoor scenarios.

Further, 5G also introduces some new positioning methods, some of which are briefly summarized below.
A new “relative time difference” based positioning method: This method is based on multi-cell round-trip time (multi-RTT) measurements. For multi-RTT positioning method, after gNBs and User Equipments (UEs) transmit Positioning Reference Signal (PRS) in downlink and Sounding Reference Signal (SRS) in uplink, respectively, the UE reports the measurement results to the Location Management Function (LMF) and the gNB reports the measurements to the LMF. By doing so, the round-trip time can be estimated and therefore ToA of one-way signal propagation between the UE and the gNB can be estimated. This method is robust against network time synchronization errors.
Angle based positioning: This kind of methods include downlink angle of departure (DL-AoD) and uplink angle of arrival (UL-AoA), which are more relevant with the usage of millimeter-wave (mmWave) and multiple antennas in 5G NR. For DL-AoD positioning method, UE provides the PRS beam received signal received power (RSRP) measurements to LMF and the gNB provides the beam azimuth and elevation angular information to LMF. For UL-AoA positioning method, the UE location is estimated based on the SRS AoA measurements taken at different antenna reception points (ARPs) of the antenna array of a Transmission/Reception Point (TRP) or at different TRPs. For either DL-AoD or UL-AoA method, LMF estimates the UE location by using the angle information, along with other configuration and deployment information, such as ARPs' center locations (or TRPs' coordinates) and beam configuration details.
Sensor Measurements: There are different varieties of sensors which have previously been discussed in 3^{rd} Generation Partnership Project (3GPP) and there is some support for providing measurements such as displacement readings from Inertial Measurement Unit (IMU) sensor and barometer pressure sensor for height computation to the location server (termed Location Management Function, LMF in NR). There are other sensors such as light sensor, camera, Light Detection and Ranging (LiDar) sensors which would play an important role in providing the rich information such as the indoor/outdoor classification, 3D models of the surroundings etc. Having this sort of information for location estimation would be finding a gold mine. The usage of these advance sensors and further the enhancement of IMU sensors in terms of reporting accelerometer, gyroscope, magnetometer readings would be an integral part of next generation localization solution.

### SUMMARY

To improve the positioning accuracy and integrity for cellular-based positioning, an international patent application, PCT/CN2022/126431, proposes an enhanced positioning scheme by exploiting multiple UEs on a same target to be positioned. A brief introduction of the enhanced positioning scheme is given below.

Considering a case where a target to be positioned (which could be either a human being or an object) carries two (or even more) 5G UEs, each of which can be a regular 5G UE, or a RedCap (reduced capability) 5G UE, or a further simplified mMTC-type UE. In practice, it is increasingly popular for a human to carry two or more UEs. Further, when there is a need for positioning a target, multiple UEs can be intentionally carried by, disposed at, installed at, attached to, or otherwise co-located with this target in advance, especially when this target is an object.

Upon using a “relative time difference” based positioning scheme (such as DL-TDoA/UL-TDoA/multi-RTT scheme), each of J (J≥2) 5G UEs, which are carried by a target to be positioned, can result in RSTDs upon the corresponding PRS/SRS ToA measurements. If the RSTD resulted by PRS/SRS transmissions between the reference access point and a neighboring access point i is denoted as RSTD_{0,i}, then, for every available i, the RSTD_{0,i} can be obtained via doing proper “syncretic processing” on the ToAs measured by J 5G UEs.

Specifically, the proposed three ways of syncretic processing include:
1) Among J (J≥2) 5G UEs, if there is at least one “all-line-of-sight-path UE or all-LOS-path UE” whose ToA measurements are all LOS-path resulted ToA measurements, it is recommended to select the ToA measurements of one of the “all-LOS-path UEs” as the output of the syncretic processing. This way can be viewed as prioritizing LOS-resulted ToA with the prioritization granularity being UE.
2) Among J (J≥2) 5G UEs, if there is no “all-LOS-path UE”, the mainly recommended way of syncretic processing is arithmetic average processing. In particular, either a uniform average or a weighted average may be performed with the weights being designed upon “path PRS RSRPs”.
3) To cover all possibly reasonable ways, the following ways can be considered as optional ways (which can be viewed as prioritizing LOS-resulted ToA with the prioritization granularity being ToA):
   3.1) Using two 5G UEs as an example, if the ToAs measured by these two UEs for PRS transmissions from an available access point include one LOS-resulted ToA and one Non-Line-Of-Sight (NLOS) resulted ToA, then the ToA from the considered access point to the target to be positioned is determined as that LOS-resulted ToA. This optional way of syncretic processing will achieve performance gain only when “the two 5G UEs are located closely enough” and “NLOS-resulted ToA offset is large enough”.
   3.2) Using two 5G UEs as an example, if the ToAs measured by these two UEs for PRS transmissions from an available access point include two LOS-resulted ToAs, then the ToA from the considered access point to the target to be positioned is determined as the one with a larger LOS-path PRS RSRP. This optional way of syncretic processing will achieve performance gain only when “the two 5G UEs are located closely enough”.

The way for signaling the information about the association between the J (J≥2) UEs:
Option 1: The association information is only signaled from a location service (LCS) Client to an LMF, via the interface between the LCS Client and a Gateway Mobile Location Center (GMLC), the interface between the GMLC and an Access and Mobility Management Function (AMF), and the interface between the AMF and the LMF. The syncretic processing on the ToAs measured by multiple UEs is performed at the LMF, and the proposed multi-UE positioning scheme is transparent to access points and UEs. Each of J UEs needs to feed back the ToA measurements over the air interface.
Option 2: On top of the above-mentioned Option 1, the association information is further signaled to the access points, via the interface between the AMF and the access points. The syncretic processing on the ToAs measured by multiple UEs can be performed at the access point(s), and the proposed multi-UE positioning scheme is just transparent to UEs. Although each of J UEs still needs to feed back the ToA measurements over the air interface, the number of ToA measurements sent from the involved access points to the LMF is less.
Option 3: On top of the abovementioned Option 2, the association information is further signaled to the UEs, via the interface between the UEs and their serving access point(s). The syncretic processing on the ToAs measured by the multiple UEs can be performed at one of J UEs, where UE aggregation is utilized to enable other UEs to send their measurements to the chosen one UE via using a UE-UE interconnection (e.g., Wi-Fi, Bluetooth). Only one of/UEs needs to feed back the syncretized ToA measurements over the air interface.

Further, a method for determining whether multiple UEs are really carried by a target to be positioned is provided as follows:
When the target to be positioned is an object, it is possible that one of J (J≥2) 5G UEs is accidentally lost although the probability of this kind of event is small. When the target to be positioned is a human being, it is possible that this person sometimes forgets to carry one of J 5G UEs even if the probability of this kind of event is not large. Thus, it is needed to design an appropriate way to determine whether J UEs are really carried by the target to be positioned or not.

Using DL-TDoA as an example of the used “relative time difference” based positioning scheme, the designed method includes the following two steps:
Step 1: Check whether the serving cell IDs of the/UEs are the same one.
Step 2: After the check at Step 1 is passed, check whether the measured PRS RSRPs of the J UEs for “any one given PRS resource which can be received and measured by these J UEs” have enough small relative differences.

With this method, it can be determined whether all J 5G UEs are really carried by the target to be positioned or not.

For the multi-UE positioning scheme recently proposed in the international patent application, PCT/CN2022/126431, further enhancements are still needed. For example, it is to be studied and determined how the association between multiple UEs is established and maintained. Further, how multi-UE positioning can be exploited.

In the abovementioned international patent application, it was assumed that the association relationship between multiple UEs is determined after the subscription of positioning service (as part of external LCS client request for positioning) and is available at the LCS Client. Of course, every time, before an incoming positioning session starts, the actual association status will be checked via a well-designed way (i.e., the way introduced above for determining whether multiple UEs are really carried by the target). For the issue about which network elements should know the information about the determined association relationship, three design options were further considered.

However, to have more flexibility and convenience in practical applications, it is meaningful to consider letting the association relationship of multiple UEs be not determined after the subscription of positioning service (LCS client has requested for positioning). In such a case, the management of the dynamic association relationship needs to be well designed accordingly.

In addition, it is still needed to consider how to leverage upon different capabilities that each device may have in terms of improving positioning accuracy.

Therefore, to address or at least alleviate at least one of the above issues, some embodiments of the present disclosure are provided.

According to a first aspect of the present disclosure, a method at a first terminal device for positioning a target that is associated with multiple terminal devices comprising the first terminal device is provided. The method comprises: obtaining an association with at least one second terminal device from the multiple terminal devices other than the first terminal device; and using association data for positioning.

In some embodiments, the method further comprises: transmitting, to a first network node, a first message indicating the association data. In some embodiments, the method further comprises: receiving, from the first network node, a second message indicating whether the association is successfully registered or not. In some embodiments, the association data indicates at least a common identifier (ID) for the association. In some embodiments, the first terminal device comprises a primary terminal device. In some embodiments, the first message indicates at least one of: an identifier associated with the first terminal device; an identifier associated with at least one or each of the at least one second terminal device; a common identifier preconfigured for the association; and an indicator indicating that the first terminal device and the at least one second terminal device are associated for positioning.

In some embodiments, the second message further indicates at least one of: a temporary identifier assigned to the first terminal device; a temporary identifier assigned to each of the at least one second terminal device; and a common identifier assigned to the association. In some embodiments, the step of obtaining the association comprises: trying, for one or more rounds, to associate the first terminal device with at least one of the multiple terminal devices based on one or more factors, which are obtained by at least one of: a pre-configuration at the first terminal device and a dynamic configuration provided from a network node. In some embodiments, the one or more factors comprise at least one of: an identifier associated with the first terminal device; an identifier associated with at least one of the at least one second terminal device; an indicator indicating which one of the first terminal device and/or the at least one second terminal device is a primary terminal device; an identifier associated with the association; a number of terminal devices in the association that are actually needed for positioning the target; an order in which the first terminal device tries to associate itself with the at least one second terminal device; whether the members in the association have a same ownership; whether the members in the association have a same synchronization reference source; whether the members in the association have same group communication; whether the members in the association have registrations to a same list; whether the members in the association have sign-ins under a same identifier; whether the members in the association have a same associated positioning request or measurement request; whether the members in the association have a same associated positioning result; whether the members in the association are quasi-collocated (QCL); and whether the members in the association have a common timing-related group; whether the members in the association have a common ID associated with the association; whether the members in the association have, for at least one radio measurement type, related measurement results that are close to each other to an extent defined by one or more thresholds; whether the members in the association have a same user or same carrier at the time of obtaining the association. In some embodiments, the step of trying is performed for the multiple terminal devices one by one in the order indicated by the one or more factors until either the number indicated by the one or more factors is reached or associations with all of the multiple terminal devices have been tried.

In some embodiments, the method further comprises: in response to receiving the second message, transmitting, to the at least one second terminal device, a message indicating at least one content indicated by the second message to trigger the at least one second terminal device to report their positioning capabilities. In some embodiments, the method further comprises: in response to determining that the association is successfully registered, transmitting, to a second network node, a third message indicating positioning capabilities of the first terminal device or positioning capabilities of both the first terminal device and the at least one second terminal device; and receiving, from the second network node, a fourth message indicating positioning configurations for the first terminal device or positioning configurations for both the first terminal device and the at least one second terminal device and/or a measurement request. In some embodiments, the positioning configuration comprises at least one of: a configuration for radio signals to be received for positioning; a configuration for radio signals to be transmitted for positioning; and a configuration for positioning measurement.

In some embodiments, the third message indicates at least one of: a temporary identifier assigned to the first terminal device; a temporary identifier assigned to each of the at least one second terminal device; a common identifier assigned to the association; a number of terminal devices that are associated with each other for positioning; and a list of capabilities, one for each of the terminal devices that are associated with each other for positioning. In some embodiments, when the fourth message indicates one or more positioning configurations for the first terminal device and the at least one second terminal device, the method further comprises: transmitting, to the at least one second terminal device, a fifth message indicating the at least one positioning configuration for the at least one second terminal device, respectively, in response to receiving the fourth message.

In some embodiments, the third message is transmitted to the second network node and the fourth message is received from the second network node without involving any of the at least one second terminal device, or the third message is transmitted to the second network node and the fourth message is received from the second network node via one or more of the at least one second terminal device. In some embodiments, the method further comprises at least one of: performing one or more measurement related operations for positioning the target based on at least the positioning configuration for the first terminal device; transmitting, to one of the at least one second terminal device, a sixth message indicating one or more measurement results obtained by the first terminal device for positioning the target; and receiving, from the at least one second terminal device, a sixth message indicating one or more measurement results obtained by the at least one second terminal device for positioning the target.

In some embodiments, before the step of transmitting the third message, the method further comprises: receiving, from one of the at least one second terminal device, a seventh message for requesting positioning the target, the step of transmitting the third message is performed in response to receiving the seventh message. In some embodiments, the method further comprises: transmitting, to the second network node, an eighth message indicating measurement results obtained by the first terminal device and/or the at least one second terminal device or indicating a filtered measurement result, which is derived by the first terminal device from the measurement results obtained by the first terminal device and/or the at least one second terminal device; and receiving, from the second network node, a ninth message indicating a positioning result for the target. In some embodiments, the eighth message is transmitted to the second network node and the ninth message is received from the second network node without involving any of the at least one second terminal device, or the eighth message is transmitted to the second network node and the ninth message is received from the second network node via one or more of the at least one second terminal device. In some embodiments, the measurement results indicated by the eighth message comprise at least one of: a list of one or more measurement results for Time of Arrival (ToA); and a list of one or more measurement results for Reference Signal Time Difference (RSTD).

In some embodiments, the common identifier assigned to the association is at least one of: an identifier identifying the association; an identifier identifying the first terminal device; an identifier identifying one of the at least one second terminal device; an identifier identifying the target; and a collection of multiple identifiers associated with multiple terminal devices that are associated with a same target and be able to perform different measurements for positioning. In some embodiments, the collection of multiple identifiers comprises at least one of: a Temporary Mobile Subscription Identifier (TMSI) associated with the first terminal device; at least one TMSI associated with the at least one second terminal device; a Layer 2 Sidelink identifier associated with the first terminal device; at least one Layer 2 Sidelink identifier associated with the at least one second terminal device; a Bluetooth identifier associated with the first terminal device; at least one Bluetooth identifier associated with the at least one second terminal device; a Wi-Fi identifier associated with the first terminal device; and a Wi-Fi identifier associated with the at least one second terminal device.

In some embodiments, the first terminal device is a primary terminal device for the association. In some embodiments, the first terminal device is determined as the primary terminal device by at least one of: a pre-configuration; a dynamic configuration; and a selection based on one or more pre-defined rules. In some embodiments, the one or more pre-defined rules comprise at least one of: the primary terminal device has the minimum capability defined for a primary terminal device; the primary terminal device has its primary cell (PCell) in a specific carrier frequency or frequency range; the primary terminal device is able to communicate with a communications network for performing a positioning service; the primary terminal device belongs to a power class defined for a primary terminal device; the primary terminal device has the strongest Reference Signal Received Power (RSRP) within the association; the primary terminal device has its RSRP at least above a threshold; the primary terminal device has a Line of Sight (LOS) path to a Radio Access Network (RAN) node comprised in a communications network; the primary terminal device has the shortest timing measurement with respect to a communications network in the association; and the primary terminal device is not a reduced capability (RedCap) terminal device. In some embodiments, the primary terminal device is able to perform at least one of: acting on behalf of the association towards nodes external to the association; performing at least one radio measurement configured for the association; transmitting at least one radio signal configured for the association; reporting radio measurements on behalf of the association; receiving a request for one or more radio measurements to be performed by the members in the association on behalf of the members in the association; forwarding assistance data to the at least one second terminal device; triggering the at least one second terminal device to perform positioning measurements; collecting radio measurements from the at least one second terminal device; acting as a synchronization reference to the at least one second terminal device; providing another node external to the association with information about the association; and informing another node external to the association about a change in the association.

In some embodiments, a location of the primary terminal device is used as a reference location for the at least one second terminal device. In some embodiments, the primary terminal device is a Quasi-Co-Location (QCL) reference for the at least one second terminal device. In some embodiments, the method further comprises at least one of: associating with a new terminal device to let the new terminal device join the association; detecting the need of initiating a new round of association establishment; reporting, to the first network node, the information about the updated association once a new terminal device has joined the association; detecting that a terminal device leaves the association; and reporting, to the first network node, the information about the updated association once a terminal device leaves the association. In some embodiments, the first network node is an Access and Mobility Management Function (AMF) or a Location Management Function (LMF), and/or the second network node is an LMF.

According to a second aspect of the present disclosure, a first terminal device is provided. The terminal device comprises: a processor; a memory storing instructions which, when executed by the processor, cause the processor to carry out any of the methods of the first aspect.

According to a third aspect of the present disclosure, a first terminal device for positioning a target that is associated with multiple terminal devices comprising the first terminal device is provided. The first terminal device comprises: an obtaining module configured to obtain an association with at least one second terminal device from the multiple terminal devices other than the first terminal device; and a using module configured to use association data for positioning. In some embodiments, the terminal device may comprise one or more further modules, each of which may perform any of the steps of any of the methods of the first aspect.

According to a fourth aspect of the present disclosure, a method at a first network node for facilitating a first terminal device in positioning a target that is associated with multiple terminal devices comprising the first terminal device is provided. The method comprises: receiving, from the first terminal device, a first message indicating association data for an association of the first terminal device with at least one second terminal device, the at least one second terminal device being from the multiple terminal devices and different from the first terminal device; determining whether the association is allowed to be registered or not; and transmitting, to the first terminal device, a second message indicating whether the association is successfully registered or not based on at least the determination.

In some embodiments, the association data indicates at least a common identifier (ID) for the association. In some embodiments, the first terminal device comprises a primary terminal device. In some embodiments, the first message indicates at least one of: an identifier associated with the first terminal device; an identifier associated with at least one or each of the at least one second terminal device; a common identifier preconfigured for the association; and an indicator indicating that the first terminal device and the at least one second terminal device are associated for positioning. In some embodiments, the second message further indicates at least one of: a temporary identifier assigned to the first terminal device; a temporary identifier assigned to each of the at least one second terminal device; and a common identifier assigned to the association. In some embodiments, the method further comprises: transmitting, to the first terminal device, a message indicating one or more factors used for selecting one or more terminal devices to be associated with the first terminal device. In some embodiments, the one or more factors comprise at least one of: an identifier associated with the first terminal device; an identifier associated with at least one of the at least one second terminal device; an indicator indicating which one of the first terminal device and/or the at least one second terminal device is a primary terminal device; an identifier associated with the association; a number of terminal devices in the association that are actually needed for positioning the target; an order in which the first terminal device tries to associate itself with the at least one second terminal device; whether the members in the association have a same ownership; whether the members in the association have a same synchronization reference source; whether the members in the association have same group communication; whether the members in the association have registrations to a same list; whether the members in the association have sign-ins under a same identifier; whether the members in the association have a same associated positioning request or measurement request; whether the members in the association have a same associated positioning result; whether the members in the association are quasi-collocated (QCL); and whether the members in the association have a common timing-related group; whether the members in the association have a common ID associated with the association; whether the members in the association have, for at least one radio measurement type, related measurement results that are close to each other to an extent defined by one or more thresholds; whether the members in the association have a same user or same carrier at the time of obtaining the association.

In some embodiments, the first terminal device is a primary terminal device for the association. In some embodiments, the method further comprises at least one of: receiving, from the first terminal device, a report indicating a join of a new terminal device into the association; and receiving, from the first terminal device, a report indicating a leave of a terminal device from the association. In some embodiments, the first network node is an Access and Mobility Management Function (AMF) and/or a Location Management Function (LMF).

According to a fifth aspect of the present disclosure, a first network node is provided. The first network node comprises: a processor; a memory storing instructions which, when executed by the processor, cause the processor to carry out any of the methods of the fourth aspect.

According to a sixth aspect of the present disclosure, a first network node for facilitating a first terminal device in positioning a target that is associated with multiple terminal devices comprising the first terminal device is provided. The first network node comprises: a receiving module configured to receive, from the first terminal device, a first message indicating association data for an association of the first terminal device with at least one second terminal device, the at least one second terminal device being from the multiple terminal devices and different from the first terminal device; a determining module configured to determine whether the association is allowed to be registered or not; and a transmitting module configured to transmit, to the first terminal device, a second message indicating whether the association is successfully registered or not based on at least the determination. In some embodiments, the first network node may comprise one or more further modules, each of which may perform any of the steps of any of the methods of the fourth aspect.

According to a seventh aspect of the present disclosure, a method at a second network node for facilitating a first terminal device in positioning a target that is associated with multiple terminal devices comprising the first terminal device is provided. The method comprises: receiving, from the first terminal device, an eighth message indicating measurement results obtained by the first terminal device and/or at least one second terminal device or indicating a filtered measurement result, which is derived by the first terminal device from the measurement results obtained by the first terminal device and/or the at least one second terminal device, the at least one second terminal device being from the multiple terminal devices and different from the first terminal device; determining a positioning result for the target based on at least the eighth message; and transmitting, to the first terminal device, a ninth message indicating the positioning result for the target.

In some embodiments, the eighth message is received from the first terminal device and the ninth message is transmitted to the first terminal device without involving any of the at least one second terminal device, or the eighth message is received from the first terminal device and the ninth message is transmitted to the first terminal device via one or more of the at least one second terminal device. In some embodiments, the measurement results indicated by the eighth message comprise at least one of: a list of one or more measurement results for Time of Arrival (ToA); and a list of one or more measurement results for Reference Signal Time Difference (RSTD). In some embodiments, before the step of receiving the eighth message, the method further comprises: receiving, from the first terminal device, a third message indicating positioning capabilities of the first terminal device or positioning capabilities of both the first terminal device and the at least one second terminal device; determining a positioning configuration for the first terminal device based on at least the positioning capabilities of the first terminal device or determining positioning configurations for both the first terminal device and the at least one second terminal device based on at least the positioning capabilities of both the first terminal device and the at least one second terminal device; and transmitting, to the first terminal device and/or the at least one second terminal device, a fourth message indicating the positioning configuration for the first terminal device or the positioning configurations for both the first terminal device and the at least one second terminal device and/or a measurement request. In some embodiments, the positioning configuration comprises at least one of: a configuration for radio signals to be received for positioning; a configuration for radio signals to be transmitted for positioning; and a configuration for positioning measurement. In some embodiments, the third message indicates at least one of: a temporary identifier assigned to the first terminal device; a temporary identifier assigned to each of the at least one second terminal device; a common identifier assigned to the association; a number of terminal devices that are associated with each other for positioning; and a list of capabilities, one for each of the terminal devices that are associated with each other for positioning.

In some embodiments, the third message is received from the first terminal device and the fourth message is transmitted to the first terminal device and/or the at least one second terminal device without involving any of the at least one second terminal device, or the third message is received from the first terminal device and the fourth message is transmitted to the first terminal device and/or the at least one second terminal device via one or more of the at least one second terminal device.

In some embodiments, the common identifier assigned to the association is at least one of: an identifier identifying the association; an identifier identifying the first terminal device; an identifier identifying one of the at least one second terminal device; an identifier identifying the target; and a collection of multiple identifiers associated with multiple terminal devices that are associated with a same target and be able to perform different measurements for positioning. In some embodiments, the collection of multiple identifiers comprises at least one of: a Temporary Mobile Subscription Identifier (TMSI) associated with the first terminal device; at least one TMSI associated with the at least one second terminal device; a Layer 2 Sidelink identifier associated with the first terminal device; at least one Layer 2 Sidelink identifier associated with the at least one second terminal device; a Bluetooth identifier associated with the first terminal device; at least one Bluetooth identifier associated with the at least one second terminal device; a Wi-Fi identifier associated with the first terminal device; and a Wi-Fi identifier associated with the at least one second terminal device.

In some embodiments, the first terminal device is a primary terminal device for the association. In some embodiments, the method further comprises at least one of: receiving, from the first terminal device, the information about the updated association once a new terminal device has joined the association; and receiving, from the first terminal device, the information about the updated association once a terminal device leaves the association. In some embodiments, the second network node is a Location Management Function (LMF).

According to an eighth aspect of the present disclosure, a second network node is provided. The second network node comprises: a processor; a memory storing instructions which, when executed by the processor, cause the processor to carry out any of the methods of the seventh aspect.

According to a ninth aspect of the present disclosure, a second network node for facilitating a first terminal device in positioning a target that is associated with multiple terminal devices comprising the first terminal device is provided. The second network node comprises: a receiving module configured to receive, from the first terminal device, an eighth message indicating measurement results obtained by the first terminal device and/or at least one second terminal device or indicating a filtered measurement result, which is derived by the first terminal device from the measurement results obtained by the first terminal device and/or the at least one second terminal device, the at least one second terminal device being from the multiple terminal devices and different from the first terminal device; a determining module configured to determine a positioning result for the target based on at least the eighth message; and a transmitting module configured to transmit, to the first terminal device, a ninth message indicating the positioning result for the target. In some embodiments, the second network node may comprise one or more further modules, each of which may perform any of the steps of any of the methods of the seventh aspect.

According to a tenth aspect of the present disclosure, a computer program comprising instructions is provided. The instructions, when executed by at least one processor, cause the at least one processor to carry out any of the methods of at least one of the first, fourth, and the seventh aspects.

According to an eleventh aspect of the present disclosure, a carrier containing the computer program of the tenth aspect is provided. In some embodiments, the carrier may be one of an electronic signal, optical signal, radio signal, or computer readable storage medium.

According to a twelfth aspect of the present disclosure, a telecommunication system for positioning a target associated with multiple terminal devices comprising a first terminal device is provided. The telecommunication system comprises: the first terminal device comprising: a processor; a memory storing instructions which, when executed by the processor, cause the processor to: obtain an association with at least one second terminal device from the multiple terminal devices other than the first terminal device; and use association data for positioning.

In some embodiments, the telecommunication system further comprises a first network node comprising: a processor; a memory storing instructions which, when executed by the processor, cause the processor to: receive, from the first terminal device, a first message indicating association data for an association of the first terminal device with at least one second terminal device; determine whether the association is allowed to be registered or not; and transmit, to the first terminal device, a second message indicating whether the association is successfully registered or not based on at least the determination.

In some embodiments, the telecommunication system further comprises: a second network node comprising: a processor; a memory storing instructions which, when executed by the processor, cause the processor to: receive, from the first terminal device, an eighth message indicating measurement results obtained by the first terminal device and/or at least one second terminal device or indicating a filtered measurement result, which is derived by the first terminal device from the measurement results obtained by the first terminal device and/or the at least one second terminal device; determine a positioning result for the target based on at least the eighth message; and transmit, to the first terminal device, a ninth message indicating the positioning result for the target.

In some embodiments, the instructions stored by the memory of the first terminal device, when executed by the processor of the first terminal device, cause the processor of the first terminal device to carry out any of the methods of the first aspect. In some embodiments, the instructions stored by the memory of the first network node, when executed by the processor of the first network node, cause the processor of the first network node to carry out any of the methods of the fourth aspect. In some embodiments, the instructions stored by the memory of the second network node, when executed by the processor of the second network node, cause the processor of the second network node to carry out any of the methods of the seventh aspect.

With some embodiments of the present disclosure, a more accurate positioning with a higher integrity can be achieved. For example, when positioning estimates are needed by a mobile phone and the phone is connected via sidelink/Bluetooth to other sensors such as watch or wearables which produce even better IMU results (for instance) when compared to the phone. In such case, it is possible to exploit the measurements from multiple devices including the phone, the watch, and/or the wearables.

Further, with some embodiments of the present disclosure, association with the primary phone can be made for other auxiliary devices. The association and different positioning capabilities can be informed to LMF (also known as, location server). The location server can assign different or same measurement requirements to associated devices and fuse the obtained measurement results to improve positioning accuracy and integrity.

Further, with some embodiments of the present disclosure, a simultaneous localization and mapping (SLAM) can be enabled.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and therefore are not to be considered limiting of its scope, the disclosure will be described with additional specificity and detail through use of the accompanying drawings.

FIG. 1 is a diagram illustrating an exemplary telecommunication network in which improved target positioning by using multiple terminal devices is applicable according to an embodiment of the present disclosure.

FIG. 2 is a flow chart illustrating an exemplary method at a terminal device for multiple terminal devices assisted target positioning according to an embodiment of the present disclosure.

FIG. 3 is a flow chart illustrating an exemplary method at a network node for multiple terminal devices assisted target positioning according to an embodiment of the present disclosure.

FIG. 4 is a diagram illustrating an exemplary procedure for positioning a target by using multiple terminal devices according to an embodiment of the present disclosure.

FIG. 5 is a flow chart illustrating an exemplary method at a first terminal device for positioning a target that is associated with multiple terminal devices comprising the first terminal device according to an embodiment of the present disclosure.

FIG. 6 is a flow chart illustrating an exemplary method at a first network node for facilitating a first terminal device in positioning a target that is associated with multiple terminal devices comprising the first terminal device according to an embodiment of the present disclosure.

FIG. 7 is a flow chart illustrating an exemplary method at a second network node for facilitating a first terminal device in positioning a target that is associated with multiple terminal devices comprising the first terminal device according to an embodiment of the present disclosure.

FIG. 8 schematically shows an embodiment of an arrangement which may be used in a terminal device or a network node according to an embodiment of the present disclosure.

FIG. 9 is a block diagram illustrating an exemplary terminal device according to an embodiment of the present disclosure.

FIG. 10 is a block diagram illustrating an exemplary first network node according to an embodiment of the present disclosure.

FIG. 11 is a block diagram illustrating an exemplary second network node according to an embodiment of the present disclosure.

FIG. 12 shows an example of a communication system in accordance with some embodiments of the present disclosure.

FIG. 13 shows an exemplary UE in accordance with some embodiments of the present disclosure.

FIG. 14 shows an exemplary network node in accordance with some embodiments of the present disclosure.

FIG. 15 is a block diagram of an exemplary host, which may be an embodiment of the host of FIG. 12, in accordance with various aspects described herein.

FIG. 16 is a block diagram illustrating an exemplary virtualization environment in which functions implemented by some embodiments may be virtualized.

FIG. 17 shows a communication diagram of an exemplary host communicating via an exemplary network node with an exemplary UE over a partially wireless connection in accordance with some embodiments of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first” and “second,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5G New Radio (5G NR), the present disclosure is not limited thereto. In fact, as long as association mechanism for positioning using multiple terminal devices are involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), Long Term Evolution (LTE), future 6G systems, etc. Therefore, one skilled in the arts could readily understand that the terms used herein may also refer to their equivalents in any other infrastructure. For example, the term “terminal device” used herein may refer to a UE, a mobile device, a mobile terminal, a mobile station, a user device, a user terminal, a wireless device, a wireless terminal, an IoT device, a vehicle, or any other equivalents. For another example, the term “network node” used herein may refer to a base station, a base transceiver station, an access point, a hot spot, a NodeB (NB), an evolved NodeB (eNB), a gNB, a DoT, a network element, a network function, or any other equivalents. Further, the term “syncretizing”, “fusing”, “combining”, and “filtering” may be used interchangeably hereinafter. Further, the term “group” and “association” may be used interchangeably hereinafter. Further, the terms “multiple”, “a plurality of”, “more than one”, “two or more”, and “at least two” may be used interchangeably hereinafter.

Further, following 3GPP documents are incorporated herein by reference in their entireties:
3GPP TS 23.273 V18.0.0 (2022-12), Technical Specification, 3rd Generation Partnership Project; Technical Specification Group Services and System Aspects; 5G System (5GS) Location Services (LCS); Stage 2 (Release 18); and
3GPP TS 38.305 V17.4.0 (2023-03), Technical Specification, 3rd Generation Partnership Project; Technical Specification Group Radio Access Network; NG Radio Access Network (NG-RAN); Stage 2 functional specification of User Equipment (UE) positioning in NG-RAN (Release 17).

Further, following publications are incorporated herein by reference in their entireties:
Satyam Dwivedi, Ritesh Shreevastav, Florent Munier, Johannes Nygren, Iana Siomina, etc., “Positioning in 5G Networks,” IEEE Communications Magazine, vol. 59, no. 11, pp. 38-44, November 2021.

As mentioned above, the management of the dynamic association relationship among multiple terminal devices (e.g., multiple UEs) associated with a same target to be positioned needs to be well designed accordingly. Further, it is still needed to consider how to leverage upon different capabilities that each device may have in terms of improving positioning accuracy.

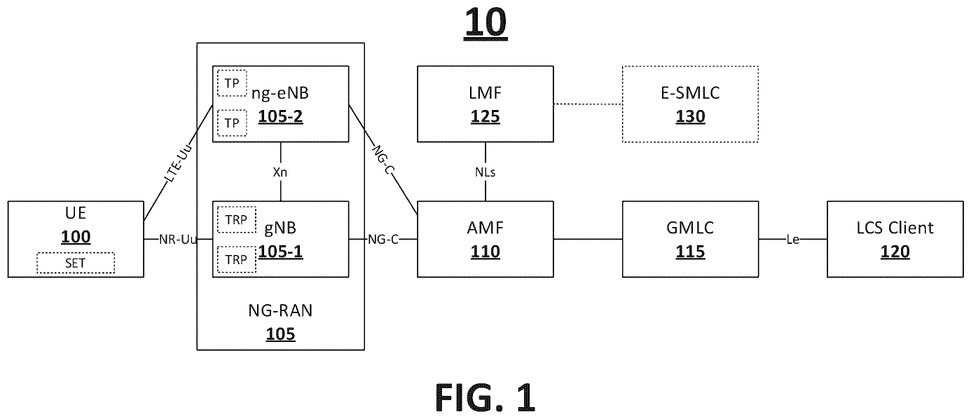

Therefore, in some embodiments, a common ID may be associated with a group or an association of multiple terminal devices. It can be used (e.g., by a UE associated with the group) to indicate association of a UE to the group during a positioning session and/or in communication with any node (other UE or network node) outside the group. In some embodiments, the common ID may be a group ID. In some embodiments, the common ID may be the ID of one of the UEs comprised in the group/association. In some embodiments, the common ID may be the positioning target ID. In some embodiments, the common ID may be used to denote a group of UEs during a positioning session. In some embodiments, the common ID can also be a collection of multiple UE/device IDs which are associated with a user (e.g., person) and can perform different measurements which can be used for positioning. In some embodiments, the common ID can be signaled between different nodes involved in a positioning session, e.g., via any interface in the FIG. 1. In some embodiments, there can be measurements associated with the group and/or group characteristics signaled together with the ID.

In some embodiments, if each device is equipped with a Subscriber Identity Module (SIM) card, the group ID can consist of multiple individual Temporary Mobile Subscription Identities (TMSIs) that each UE would have (the temporary identifier that each UE would have obtained after the registration with AMF). If the devices are not equipped with SIM cards, the ID can be Layer 2 ID from Sidelink (PC5) or Bluetooth ID or Wi-Fi associated ID etc.

In some embodiments, a group of UEs may comprise a primary UE, which may also be called a master UE, an anchor UE, etc. In some embodiments, the primary UE can be pre-configured, can be configured dynamically, and/or can be selected based on pre-defined rules, etc. In some embodiments, the primary UE can have at least one group responsibility. In some embodiments, it can also act on behalf of other UEs in the group towards nodes external to the group, e.g., send measurements associated with the group and/or group characteristics, as well as other data according to the primary UE responsibilities (see more examples below).

In some embodiments, a combination of one or more of the embodiments described above is also possible.

Further, to address or at least partially alleviate the issues mentioned above, some example solutions according to some embodiments of the present disclosure, which are built based on the above proposals, are briefly summarized below:
For the newly considered design option that the association relationship between multiple UEs is not determined after the subscription of positioning service, one of the multiple UEs in the group may be configured to be the primary UE and it may be responsible for i) initiating and maintaining the possibly varying association relationship via UE-UE interconnection and ii) reporting the dynamic variation of association relationship (including newly happened association and newly happened dissociation) to the LMF.
This option can enable a more flexible and convenient implementation of the multi-UE positioning scheme. For this option, well-designed mechanisms used for the management of the dynamic association relationship are provided.

FIG. 1 is a diagram illustrating an exemplary telecommunication system 10 in which improved target positioning by using multiple terminal devices is applicable according to an embodiment of the present disclosure. Although the telecommunication system 10 is a system defined in the context of 5GS, the present disclosure is not limited thereto. As shown in FIG. 1, the system 10 may comprise one or more UEs 100, a Radio Access Network (RAN) 105 and some network nodes/functions related to positioning.

In some embodiments, the RAN 105 may be a Next Generation RAN (NG-RAN). However, the present disclosure is not limited thereto. In some other embodiments, the RAN 105 may be an Evolved Universal Terrestrial Radio Access Network (E-UTRAN) or a RAN based on another RAT. Referring to FIG. 1, the NG-RAN 105 may comprise one or more RAN nodes, such as a gNB 105-1 and an ng-eNB 105-2, which may provide the UE 100 with access based on one or more Radio Access Technologies (RATs). For example, the gNB 105-1 may provide the UE 100 with NR access, and the ng-eNB 105-2 may provide the UE 100 with Evolved Universal Terrestrial Radio Access (E-UTRA) access. The RAN 105 may be involved in the handling of various positioning procedures including positioning of a target UE, provision of location related information not associated with a particular target UE and transfer of positioning messages between an AMF or LMF and a target UE. The RAN 105 may support determination of location estimates in geographical and/or local co-ordinates.

Further, as shown in FIG. 1, the system 10 may further comprise one or more network nodes, such as an AMF 110, a GMLC 115, an LCS client 120, an LMF 125, and an Enhanced Serving Mobile Location Center (E-SMLC) 130. Please note that the present disclosure is not limited thereto. In some other embodiments, the system 10 may comprise more nodes, less nodes, or different nodes that can be substituted for the nodes shown in FIG. 1.

In some embodiments, the AMF 110 may contain functionality responsible for managing positioning for a target UE for all types of location request. The AMF 110 may be accessible to the GMLC 115 via the Namf interface, to the RAN 105 via the N2 or NG-C reference point and to the UE 100 via the N1 reference point (which is enabled by the NG-C and NR-Uu/LTE-Uu reference points).

In some embodiments, the LMF 125 may manage the overall co-ordination and scheduling of resources required for the location of a UE that is registered with or accessing the 5G Core Network (CN). It may also calculate or verify a final location and any velocity estimate and may estimate the achieved accuracy. The LMF 125 may receive location requests for a target UE (e.g., the UE 100) from the serving AMF 110 using the Nlmf interface. The LMF 125 may interact with the UE 100 in order to exchange location information applicable to UE assisted and UE based positioning methods, and may interact with the NG-RAN 105 in order to obtain location information.

In some embodiments, the LMF 125 may determine the result of the positioning in geographical co-ordinates and/or in local co-ordinates. If requested and if available, the positioning result may also include the velocity of the UE 100. The coordinate type(s) may be determined by the LMF 125 when receiving a location request, based on LCS Client type and supported Geographical Area Description (GAD) shapes. If the location request indicates regulatory LCS Client type, the LMF 125 may determine a geographical location and optionally a location in local coordinates. For a location request that indicates a value added LCS Client type, the LMF 125 may determine the UE location in local coordinates or geographical co-ordinates or both. If the supported GAD shapes are not received or Local Co-ordinates are not included in the supported GAD shapes, the LMF 125 may determine a geographical location.

In some embodiments, the GMLC 115 may contain functionality required to support LCS. In one Public Land Mobile Network (PLMN), there may be more than one GMLC 115. The GMLC 115 may be the first node an external LCS client (e.g., the LCS client 120) accesses in a PLMN (i.e. the Le reference point is supported by the GMLC 115). Application Functions (AFs) and Network Functions (NFs) may access the GMLC 115 directly or via a Network Exposure Function (NEF). The GMLC 115 may request routing information and/or target UE privacy information from a UDM via the Nudm interface. After performing authorization of an external LCS Client or AF and verifying target UE privacy, the GMLC 115 may forward a location request to either a serving AMF (e.g., the AMF 110) using Namf interface or to a GMLC in another PLMN using the Ngmlc interface in the case of a roaming UE.

In some embodiments, AFs and NFs, as the LCS client 120, may access LCS services from the GMLC 115 in the same trust domain (e.g. in the same PLMN) using the Ngmlc interface or Event Exposure with location information from the AMF 110 in the same trust domain using the Namf interface. The LCS Client 120 may access LCS services from the GMLC 115 using the Le reference point. Further, external AFs may access LCS services from an NEF using Nnef interface or Common Application Programming Interface (API) Framework (CAPIF) for northbound APIs. Furthermore, the LCS Client 120 may access LCS services from a UE (e.g., the UE 100) over a user plane connection for reporting of location events by the UE for a periodic or triggered 5G Core Mobile Terminated Location Request (5GC-MT-LR) when the UE is able to determine location estimates.

In some embodiments, the system 10 may further comprise a UDM. In some embodiments, the UDM may contain LCS subscriber LCS privacy profile and routing information. The UDM may be accessible from the AMF 110, the GMLC 115 or an NEF via the Nudm interface. The UDM may also contain an indication whether a UE (e.g., the UE 100) is allowed to serve as a PRU as part of the UE subscription data. Further, the UDM may also contain LMF identifier(s) in UE LCS subscription data.

As shown in FIG. 1 and also as mentioned above, the AMF 110 may receive a request for some location service associated with a particular target UE (e.g., the UE 100) from another entity (e.g., the GMLC 115 or another UE), or the AMF 110 itself may decide to initiate some location service on behalf of a particular target UE (e.g., for an Internet Protocol Multimedia System (IMS) emergency call from the UE). The AMF 110 may then send a location services request to the LMF 125. The LMF 125 may process the location services request which may include transferring assistance data to the target UE to assist with UE-based and/or UE-assisted positioning and/or may include positioning of the target UE. The LMF 125 may then return the result of the location service back to the AMF 110 (e.g., a position estimate for the UE). In the case of a location service requested by an entity other than the AMF 110 (e.g., the GMLC 115 or UE), the AMF 110 may return the location service result to this entity.

Further, as also shown in FIG. 1, an NG-RAN node (e.g., the gNB 105-1, the ng-eNB 105-2) may control several TRPs/Transmission Points (TPs), such as remote radio heads, or DL-PRS-only TPs for support of PRS-based Terrestrial Beacon System (TBS).

Further, the LMF 125 may have a proprietary signaling connection to the E-SMLC 130 which may enable the LMF 125 to access information from Evolved Universal Terrestrial Radio Access Network (E-UTRAN) (e.g. to support the OTDOA for E-UTRA positioning method using downlink measurements obtained by a target UE of signals from eNBs (e.g., the ng-eNB 105-2) and/or PRS-only TPs in E-UTRAN).

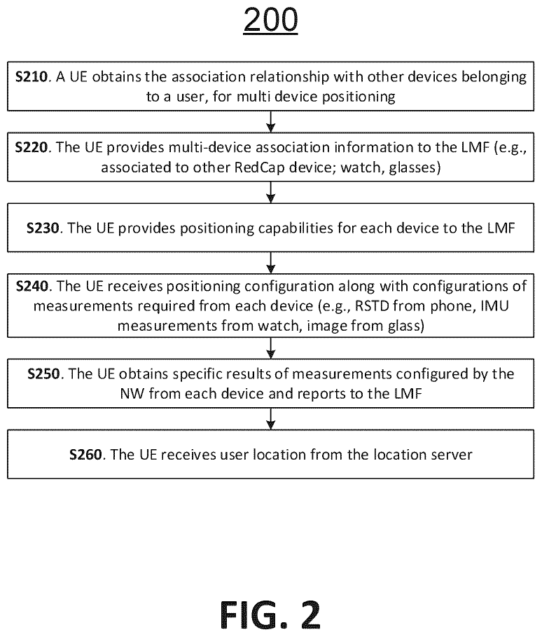

Next, some embodiments of multiple terminal devices assisted target positioning, in which the association mechanism for the multiple terminal devices, will be described with reference to FIG. 2 through FIG. 4 in detail.

FIG. 2 is a flow chart illustrating an exemplary method 200 at a terminal device (e.g., the UE 100) for multiple terminal devices assisted target positioning according to an embodiment of the present disclosure. The method 200 may be performed at a terminal device (e.g., the UE 100 shown in FIG. 1). The method 200 may comprise steps S210 through S260. However, the present disclosure is not limited thereto. In some other embodiments, the method 200 may comprise more steps, less steps, different steps, or any combination thereof. Further the steps of the method 200 may be performed in a different order than that described herein. Further, in some embodiments, a step in the method 200 may be split into multiple sub-steps and performed by different entities, and/or multiple steps in the method 200 may be combined into a single step.

The method 200 may begin at step S210 where a UE may obtain an association relationship with other devices (e.g., other UEs) belonging to a user, for multi device based positioning.

At step S220, the UE may provide multi-device association information to an LMF (e.g., indicating that the UE is associated to other RedCap device, such as a smart watch or smart glasses, etc.).

At step S230, the UE may provide positioning capabilities for each device in the association to the LMF. For example, when the UE is a primary UE for the association.

At step S240, the UE may receive positioning configurations along with configurations of measurements required from each device in the association (e.g., RSTD measurements for a smart phone, IMU measurements for a smart watch, or image-based measurements for smart glasses).

At step S250, the UE may obtain, from each device in the association, specific results of measurements configured by the network (NW), and report them to the LMF.

At step S260, the UE may receive user location information or a positioning result from the location server, such as, the LMF.

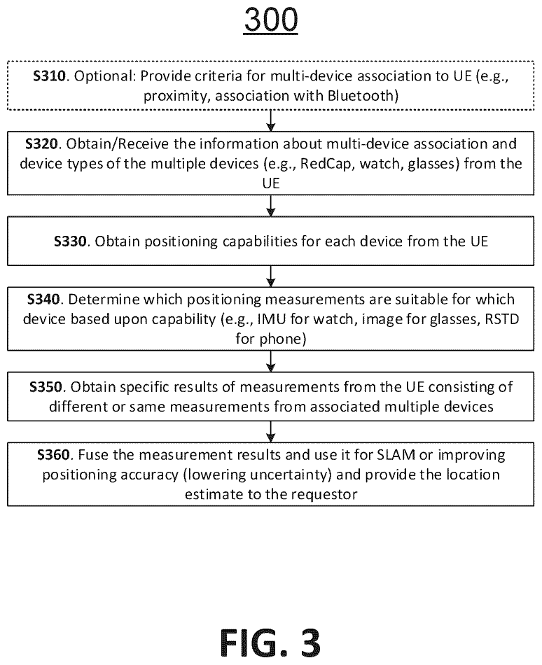

FIG. 3 is a flow chart illustrating an exemplary method at a network node for multiple terminal devices assisted target positioning according to an embodiment of the present disclosure. The method 300 may be performed at a network node (e.g., the RAN nodes 105-1, 105-2, the AMF 110, the LMF 125 shown in FIG. 1). The method 300 may comprise steps S310 through S360. However, the present disclosure is not limited thereto. In some other embodiments, the method 300 may comprise more steps, less steps, different steps, or any combination thereof. Further the steps of the method 300 may be performed in a different order than that described herein. Further, in some embodiments, a step in the method 300 may be split into multiple sub-steps and performed by different entities, and/or multiple steps in the method 300 may be combined into a single step.

The method 300 may begin at step S310 where the network node may provide a UE with criteria for multi-device association (e.g., proximity related criteria (e.g., distances between the devices shall be less than 1 meter), or the association shall be achieved by a certain wireless technology (e.g., Wi-Fi, Bluetooth), etc.). However, this step S310 may be optional. In some other embodiments, the criteria for association may be pre-configured at the UE, or the criteria for association may be dynamically determined based on the environment.

At step S320, the network node may obtain and/or receive the information about multi-device association and/or device types of the multiple devices (e.g., RedCap, smart watch, smart glasses) from the UE.

At step S330, the network node may obtain positioning capabilities for each device from the UE.

At step S340, the network node may determine which positioning measurements are suitable for which device based on the capabilities (e.g., IMU for the smart watch, image based measurements for the smart glasses, and RSTD for the smart phone).

At step S350, the network node may obtain specific results of measurements from the UE consisting of different or same measurements from the associated multiple devices.

At step S360, the network node may fuse/combine/syncretize the measurement results and use it for SLAM or improving positioning accuracy (and/or lowering uncertainty) and provide the location estimate to the requestor.

With some embodiments of the present disclosure, it is possible to exploit the measurements from multiple devices to locate a same target. For example, when positioning estimates would be needed by a mobile phone and the phone is connected via Sidelink/Bluetooth to other sensors such as watches or wearables which produce even better IMU results (for instance) when compared to the phone, some embodiments of the present disclosure provide a mechanism for associating the multiple devices and positioning the mobile phone (or its user) by using the multiple devices. With some embodiments of the present disclosure, association with the primary device (e.g., a mobile phone) can be made for other auxiliary devices (e.g., a watch, glasses, etc.). With some embodiments of the present disclosure, the association and different positioning capabilities can be informed to LMF (aka, location server). With some embodiments of the present disclosure, the location server can assign different or same measurement requirements to associated multiple devices and fuse the obtained measurement results to improve positioning accuracy and integrity. With some embodiments of the present disclosure, SLAM can be supported.

Although an embodiment of target positioning by using multiple terminal devices is described from a terminal device's perspective and a network node perspective with reference to FIG. 2 and FIG. 3, respectively, the present disclosure is not limited thereto.

For example, it is described in the above embodiment that the terminal device (e.g., a UE) may provide the positioning capabilities for each device to the network node (e.g., an LMF) at step S230/S330 and obtain corresponding positioning configurations for each device from the network node at step S240/S340, that is, the terminal device/UE may function as a primary terminal device/UE for the association/group. However, the present disclosure is not limited thereto. In some other embodiments, each of the terminal devices/UEs in the association/group may provide its own capabilities to the network node directly, and obtain its own configuration from the network node directly. Similarly, each of the terminal devices/UEs in the association/group may provide the network node with its own measurement results directly, instead of via the primary terminal device/UE and/or receive from the network node the positioning result. In some embodiments, some of the terminal devices/UEs in the group/association may provide capabilities and/or receive configurations via the primary terminal device/UE, while rest of the terminal devices/UEs in the group/association may provide capabilities and/or receive configurations directly without involving the primary UE/terminal devices.

Further, in some other embodiments, the measurement results obtained by each of the terminal devices/UEs in the group/association may be fused/combined/filtered at one or more of the terminal devices/UEs in the group/association, instead of at the network node shown at step S360 in FIG. 3. Furthermore, in some other embodiments, each of the terminal devices/UEs in the group/association may register the group/association (or more specifically, its own association with the group/association) with the network node directly, instead of via the primary terminal device/UE shown at step S220 in FIG. 2 and step S320 in FIG. 3.

Further, it is also possible for a UE/terminal device to register the group/association, report its capability, receive configuration, report measurement result, and/or receive positioning result via indirect inter-UE/terminal device communication. For example, when 3 UEs are associated with a same target to be positioned, a UE1 supports Wi-Fi communication only, a UE2 supports Bluetooth and 5G NR communications but not Wi-Fi communication, and a UE3 supports Wi-Fi and Bluetooth communication only. In such a case, the UE2 may function as a primary UE for the association, and the UE3 may function as a relay between the UE1 and the UE2. In such a case, the UE1 can be also used for positioning the target when the UE2 is the primary UE for the association.

Further, it is also possible that there are more than one primary UE/terminal devices in the group/association, such that a more robust communication between the group and the network node may be enabled.

In some embodiments, the term “radio measurement” can comprise but not limited to, e.g., Radio Resource Management (RRM) measurement (e.g., cell identification, SSB index, received signal strength, RSRP, PRP, received signal quality, RSRQ, SINR, RSSI, etc.), positioning measurement, unprocessed raw data, layer 1 (L1) measurements, layer 2 (L2) measurements, or layer 3 (L3) measurements or a function of them, e.g., timing measurements (e.g., TOA, RTOA, Rx-Tx time difference, RTT, timing advance, TDOA, propagation delay, delay spread, etc.), fingerprint measurements, power delay profile, multipath measurement result, multipath profile, received power or signal quality (e.g., RSSI, RSRP, RSRQ, SINR, Es/Iot, L1-RSRP, L1-RSRQ, power distribution, etc.), pathloss, angle measurements (angle of arrival, angle of departure), timing of one or more correlation peaks, average/median/distribution of a plurality of sensing measurements, channel state estimation, range measurements, code phase measurements, pseudorange, Doppler measurements, carrier phase measurements, accumulated delta range, Doppler measurements, Doppler shift, Doppler frequency, velocity, unprocessed raw data comprising I/Q samples, baseband signal, RF signal, ranging measurements, multipath measurements, timing of one or more correlation peaks, channel state or quality measurement or estimation (rank indication or RI, PMI, CSI, CQI etc.), radio link evaluation or monitoring (RLM), beam measurement (BM) (BM may also be called as link recover procedure), beam evaluation or beam management, beam failure detection (BFD), candidate beam detection (CBD), signal detection, synchronization. RLM may further comprise of out of sync (OOS) detection, in-sync (IS) detection etc. Examples of L1 measurements are measurements performed for RLM, BM, L1-RSRP, L1-SINR etc. etc.

In some embodiments, the term “UE” can refer to any type of wireless device communicating with a network node and/or with another UE in a cellular or mobile communication system. Examples of UE are (but not limited to) mobile device, target device, device to device (D2D) UE, vehicular to vehicular (V2V), sidelink (SL) UE, machine type UE, MTC UE or UE capable of machine to machine (M2M) communication, PDA, tablet, mobile terminals, smart phone, laptop embedded equipment (LEE), laptop mounted equipment (LME), USB dongles, smartphone, Apple iOS device, iPhone, iPod Touch, iPad, mobile device, digital media player, smartwatch, the Apple TV, the Apple Watch, reduced capacity or reduce capability UE, RedCap UE, NB-IoT UE, ambient IoT UE, etc.

In some embodiments, the term “radio signal” or “RS” can comprise any physical signal or physical channel. Physical signal may also be called reference signals (RS). Some examples of DL physical signals are positioning signals, synchronization signals, PSS, SSS, CSI-RS, DMRS, signals in SSB, discovery reference signals, DRS, CRS, positioning reference signals (PRS), tracking signals, TRS, RLM signals, RLM-RS, beam management signals, BFD-RS, BM-RS, etc. Examples of UL physical signals are Sounding Reference Signals (SRS), DMRS etc. RS may be periodic, e.g., RS occasion carrying one or more RSs may occur with certain periodicity e.g. 20 ms, 40 ms etc. The RS may also be aperiodic. Each SSB carries NR-PSS, NR-SSS and NR-PBCH in 4 successive symbols. One or multiple SSBs are transmit in one SSB burst which is repeated with certain periodicity e.g. 5 ms, 10 ms, 20 ms, 40 ms, 80 ms and 160 ms. The UE is configured with information about SSB on cells of certain carrier frequency by one or more SS/PBCH block measurement timing configuration (SMTC) configurations. The SMTC configuration comprises parameters such as SMTC periodicity, SMTC occasion length in time or duration, SMTC time offset wrt reference time (e.g. serving cell's SFN) etc. Therefore, SMTC occasion may also occur with certain periodicity e.g. 5 ms, 10 ms, 20 ms, 40 ms, 80 ms and 160 ms. The SMTC occasion may contain one or more RSs such as SSBs. The term physical channel refers to any channel carrying higher layer information, e.g., data, control etc. Examples of physical channels are data channel, control channel, PBCH, NPBCH, PDCCH, PDSCH, sPUCCH, SPDSCH, sPUCCH, sPUSCH, MPDCCH, NPDCCH, NPDSCH, E-PDCCH, PUSCH, PUCCH, NPUSCH etc.

In some embodiments, a group of UEs can comprise two or more UEs, the group may be characterized by physical proximity of the UEs of the group. The level of the physical proximity (e.g., within 1 meter or 5 meters) can be pre-configured, pre-defined, configured by an application or another node, e.g., a network node. In some examples, the group may change over time, e.g., one or more UEs leaving or joining, e.g., depending on the proximity to at least one of the other group members; for example, one UE can be forgotten at home or lost and therefore it needs to be removed from the group.

In some embodiments, the relation among UEs in the group may be further characterized by any one or more of:
same ownership (same owner of all the UEs in the group),
same synchronization reference source or same SyncRef,
same group communication (e.g., via sidelink interface, PC5 interface, device-to-device links, Bluetooth, etc.),
registration to the same list (e.g., in a profile),
signing in under the same ID (e.g., Apple ID),
the same associated positioning request (e.g., requesting to determine the location of the group of UEs),
the same associated positioning result (e.g., location of the group of UEs),
common ID associated with the group,
for at least one radio measurement type (e.g., RSRP, timing measurement,
Doppler, DL measurement, UL measurement, etc.), the measurement results associated with different UEs within the same group are the same or similar or have the same or similar characteristics (the two measurement results can comprise a first measurement result at UE1 and a second measurement result at UE2 for RS transmitted from the same network node; or the two measurement results are obtained by a network node based on RS1 received from UE1 and RS2 received from UE2 respectively), e.g.:
   RSRP1 and RSRP2 do not differ by more than a threshold,
   Two measurement results are characterized by the same or almost the same Doppler,
   Time of arrival 1 and time of arrival 2 do not differ by more than a threshold, etc.
same user or same carrier at the time of forming the association, e.g.:
   For example: only the devices used by a same person or a same carrier are used for positioning, but not the UE lent to a friend which is also nearby,
quasi-collocation (QCL): UEs in the same group or their radio signals can be defined as quasi-collocated or having the same or similar location or radio characteristics (e.g., Doppler characteristic, Doppler shift, Doppler spread, average delay, delay spread, power-delay profile, spatial receiver parameter, beam forming properties of the transmitted radio signals like dominant Angle of Arrival, average Angle of Arrival at the receiving side, etc.), in some examples,
common timing-related group (e.g., common Timing Error Group (TEG)): UEs in the same group or their radio signals can be associated with the same timing-related group.
for example, multiple UEs can appear to another radio node (UE or radio network node) as one super UE with multiple antennas or antenna panels, where the delays between the transmissions/receptions from/at multiple UEs may differ by a value associated with a timing-related group.

In some embodiments, the non-limiting term “UE” may refer to any type of wireless device communicating with a network node and/or with another UE in a cellular or mobile communication system. Examples of UE are mobile device, target device, device to device (D2D) UE, vehicular to vehicular (V2V), sidelink (SL) UE, machine type UE, MTC UE or UE capable of machine to machine (M2M) communication, PDA, tablet, mobile terminals, smart phone, laptop embedded equipment (LEE), laptop mounted equipment (LME), USB dongles, smartphone, Apple IOS device, iPhone, iPod Touch, iPad, mobile device, digital media player, smartwatch, smart glasses, camera, the Apple TV, the Apple Watch, etc.

In some embodiments, a common ID may be associated with the group. It can be used (e.g., by a UE associated to the group) to indicate association of a UE to the group during a positioning session and/or in communication with any node (other UE or network node) outside the group. In some embodiments, the common ID may be a group ID. In some embodiments, the common ID may be the ID of one of the UEs comprised in the group. In some embodiments, the common ID may be the positioning target ID. In some embodiments, the common ID may be used to denote the group of UEs during a positioning session. In some embodiments, the common ID can also be a collection of IDs of multiple UEs/devices which are associated with a user (e.g., a person) and can perform different measurements being able to be used for positioning. In some embodiments, the common ID can be signaled between different nodes involved in a positioning session, e.g., via control-plane or user plane, via higher layer protocols (e.g., a positioning protocol, LTE Positioning Protocol (LPP), extensions of LPP, etc.) and/or any interface/reference point shown in FIG. 1. In some embodiments, there can be measurements associated with the group and/or group characteristics signaled together with the ID.

In some embodiments, if each device is equipped with a SIM card, the group ID can consist of multiple individual TMSI that each UE would have (the temporary identifier that each UE would have obtained after the registration with AMF). If the devices are not equipped with a SIM card, the ID can be a Layer 2 ID from Sidelink (PC5) or Bluetooth ID or Wi-Fi associated ID etc.

In some embodiments, a group of UEs may comprise a primary UE, which may also be called as a master UE, an anchor UE, etc. In some embodiments, the primary UE can be pre-configured, can be configured dynamically, and/or can be selected based on pre-defined rules, etc. In some embodiments, example of the rules may comprise (but not limited to): the primary UE must have the minimum capability defined for primary UEs, the primary UE must have its PCell in a specific carrier frequency or frequency range such as FR1, the primary UE must be able to communicate with the communications network performing positioning service, the primary UE belongs to a power class defined for primary UEs, the primary UE has the strongest RSRP within the group or its RSRP is at least above a threshold, the primary UE has LOS to a BS comprised in the communications network, the primary UE has the shortest timing measurement with respect to the communications network in the group, etc. In some embodiments, the primary UE can also act on behalf of other UEs in the group towards nodes external to the group, e.g., send measurements associated with the group and/or group characteristics, as well as other data according to the primary UE responsibilities (see more examples below). The primary UE can have (but not limited to) at least one group responsibility, e.g.:
performing at least one radio measurement configured for the group,
transmitting at least one radio signal configured for the group,
acting towards at least one other node (e.g., a network node or another UE external to the group) on behalf of the plurality of the UEs in the group, e.g., radio measurement reporting, receiving a request for radio measurements to be performed by the group members if the design option for this step is to let other UEs in the group not to receive the positioning request from a network node,
forwarding assistance data to the UEs in the group,
trigger UE members in the group to perform positioning measurement,
collecting radio measurements within the group,
acting as a synchronization reference to the UEs in the group,
providing to another node (e.g., a network node) information about the group, e.g., number of registered UEs in the group, number of active UEs (i.e., currently associated UEs) in the group, etc.,
informing another node (e.g., a network node) about a change in the group (e.g., a new UE is added, a UE is removed, a UE is replaced, etc.).

In some embodiments, the location of the primary UE can be used as a reference location for (relative) location of at least one UE in the group.

In some embodiments, the primary UE can be a Quasi-Co-Location (QCL) reference for other UEs in the group. In some embodiments, at least one UE in the group can be quasi-collocated (QCL-ed) to the primary UE, or radio signals from the one UE in the group can be quasi-collocated (QCL-ed) to the primary UE, quasi-colocation is an indication of that the one UE in the group inherits some properties from the primary UE (e.g., location, velocity, or radio-related properties such radio conditions at its receiver, radio signal transmissions, etc.).

In some embodiments, one or more combinations of the above embodiments are also possible. Therefore, the above embodiments can be implemented independently or may also be combined with each other in any possible way. For example, there can be a primary UE among the UEs in the group characterized by a group ID.

In some embodiments, one of J registered UEs, which are candidate partner UEs for multi-UE positioning, may be configured to be the primary UE (or called anchor UE). In some embodiments where J=2, if the two UEs consist of a regular UE (e.g., a mobile phone) and a Redcap UE (e.g., a smart watch or smart glasses), it may be recommended to choose the regular UE as the primary UE. In some embodiments, this configuration can be performed by a customer when subscribing the positioning service, or by the LCS Client during the process of positioning service subscription, or by the LMF.

In some embodiments, after a customer completes the subscription of positioning service, although the association relationship has not been established, one or more of the following information may be available at the LCS Client and will be signaled from the LCS Client to the LMF via Mobile Location Protocol (MLP):
The customer-realized identities (e.g., Mobile Directory Number, IMSI/TMSI, BT-ID, WI-FI-ID, PC5 L2-ID) of all J candidate partner UES;
The info about which one candidate partner UE is configured as the primary UE, if the primary UE is configured by the customer of positioning service or by the LCS Client, or if the primary UE is configured by the NW node such as AMF or LMF or can be determined based upon UE (the most capable UE may by default become the primary UE);
A pre-configured common group ID (which takes effect once the association between at least two of J (J≥2) candidate partner UEs is established), if the common group ID is pre-configured at the location server (or by AMF at the registration procedure) or is configured by the UE or provided via LCS Client.

In some embodiments, upon receiving the information sent from the LCS Client for the multi-device positioning request, the LMF may perform one or more of the following actions:
Transform the customer-realized identities of all J candidate partner UEs to be the International Mobile Subscriber Identity (IMSI) or Temporary Mobile Subscriber Identity (TMSI) of all J candidate partner UEs.
Configure the primary UE, if it has not been provided by the LCS client (UEs based upon the capabilities) or the Location server or AMF.
Pre-configure a common group ID which takes effect once the association between at least two of J candidate partner UEs is established, if it has not been configured by the LCS Client.
Configure the actually needed number of associated UEs, which is denoted as K (1≤K≤J); here, K=1 means the multi-UE positioning is degraded to the existing single-UE positioning. Further, if K>1, configure the “partner checking order” among “J−1 candidate partner UE(s) excluding the primary UE; this “partner checking order” may be used when the primary UE tries to associate other K−1 partner UE(s).

In some embodiments, sometimes, maybe J is kind of large; but, when a few of candidate partner UEs (e.g., two UEs) are associated, the enhancement of positioning accuracy and integrity has been enough. In addition, sometimes, maybe the requirement on positioning accuracy is not that high, so that it is not necessary to exploit the multi-UE positioning. These cases can be handled well with flexibly configuring the value of the variable K.

In some embodiments, the value of K can be adjusted on demand.
Send the primary UE the following information via LPP: the IMSI/TMSI of J candidate partner UEs, which one candidate partner UE is the primary UE, the pre-configured common group ID, the actually needed number of associated UEs (i.e., K), and the “partner checking order” among “J−1 candidate partner UE(s) excluding the primary UE”.

In some embodiments, if K>1 (i.e., it is necessary to exploit the multi-UE positioning), the primary UE may be responsible for i) initiating and maintaining the possibly varying association relationship via UE-UE interconnections (e.g., Bluetooth, Wi-Fi) and/or ii) reporting the dynamic variation of association relationship (including newly happened association and newly happened dissociation) to the LMF.

In some embodiments, in the 1^{st} round of association establishment, the primary UE may utilize inter-UE connection to try to build the association between itself and other K−1 candidate partner UE(s). Specifically, using Bluetooth as the example of inter-UE connection approach, the process is described as below:
In some embodiments, according to the “partner checking order” indicated by the LMF, the primary UE may try to build the association relationship with a candidate partner UE, for example, by initiating Bluetooth pairing request to this candidate partner UE. After this candidate partner UE can be paired successfully via Bluetooth, the primary UE may ask this candidate partner UE to send the measured SSB RSRPs to the primary UE. Once the measured SSB RSRPs of the primary UE and this candidate partner UE have enough small relative difference (which means these two UEs are really carried together by the positioned target), this candidate partner UE may be associated with the primary UE.
   Note: the effective inter-device distance for Bluetooth pairing is around 8 meters; thus, it is not enough to only use Bluetooth pairing to determine the association relationship.
In some embodiments, once the total number of associated UEs reaches K or all of other J−1 candidate partner UE(s) have been checked, the primary UE may stop the further attempt of association establishment.

In some embodiments, at the end of the 1^{st} round of association establishment, the total number of associated UEs will be either equal to K for most of time or smaller than K sometimes (e.g., some candidate partner UEs ran out of battery or the positioned target forgot to bring some candidate partner UEs). Then, regardless of whether the total number of associated UEs is equal to or less than K (where 1<K≤J), the primary UE may inform the current situation of inter-UE association and the corresponding common group ID to the LMF via LPP.

In some embodiments, after the 1st round of association establishment, the variation of association relationship will happen for the following two kinds of situations:
1) Once one of already associated partner UEs is disassociated due to some certain reason (e.g., being out of power or lost from the positioned target), the primary UE may inform the variation of inter-UE association to the LMF via LPP. As an example, the disassociation can be identified by the primary UE because of losing Bluetooth pairing with the corresponding partner UE. As another example, the disassociation can be identified by the primary UE because the relative difference of the SSB RSRPs measured by the primary UE and this candidate partner UE is larger than a pre-defined threshold. This can happen when a smart watch is put in a room by the positioned person and this person stays at another neighboring room of the same house with carrying a mobile phone; in this case the Bluetooth pairing between the mobile phone (i.e., the primary UE) and the smart watch (i.e., a partner UE) is still active, but the two UEs have not been on the same location.
2) Before an incoming positioning session starts, if the current value of the total number of associated UEs is smaller than K, the primary UE may initiate a new round of association establishment to try to make the total number of associated UEs be increased to K. After this round of association establishment, if at least one candidate partner UE is newly associated with the primary UE, the primary UE may inform the updated situation of inter-UE association to the LMF via LPP.

In some embodiments, if the used “relative time difference” based positioning scheme is DL-TDoA or multi-RTT scheme, during the process of any one ongoing positioning session, each of the other associated partner UEs send its PRS-resulted ToA measurements to the primary UE via using an inter-UE connection (e.g., Wi-Fi, Bluetooth). Then, the primary UE may feed back the syncretized ToA measurements over the air interface. In this way, from the perspective of the other associated partner UEs, the primary UE may act like a UE-to-Network relay.

In some embodiments, the positioning request can of course be sent to each of J candidate partner UEs from the LMF via LPP.

However, in some embodiments, with the awareness of the multi-UE association at the UE side, it may be recommended to let the LMF only send the positioning request to the primary UE; then, every time when a positioning session will start, via the inter-UE connection, the primary UE may send the positioning request to the other associated partner UEs. By doing so, for the UE(s) which currently are not associated with the primary UE, unnecessary positioning-related radio measurements can be avoided and power saving can be achieved.

In some embodiments, further steps of multi-device positioning procedure may comprise (but not limited to) one or more of:
Obtain UE/device capabilities of each device (via primary UE).
Assign positioning measurements to each device based upon the knowledge as what each device is best to perform the measurements on. (e.g., if a device is a watch it would be capable of doing sensor measurements, such as IMU displacement results, smart glasses to provide camera vision, a regular phone to provide RSTD measurements). If all the devices are capable of performing same measurements, then measurements can also be aggregated and best measurements (whichever has lower uncertainty can be considered).
Fuse the measurements and improve the positioning accuracy.

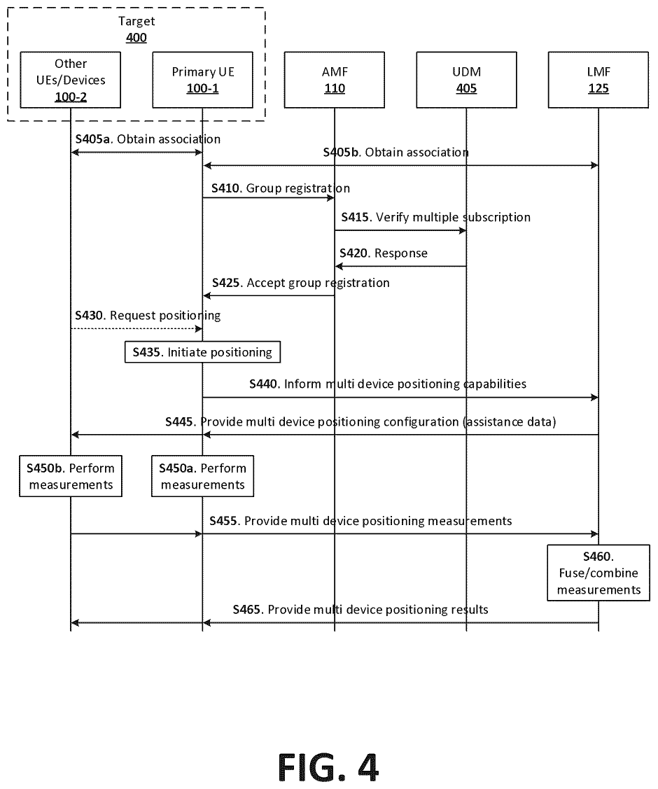

In some embodiments, for an example solution where the primary UE is responsible for i) initiating and maintaining the possibly varying association relationship via UE-UE interconnection and ii) reporting the dynamic variation of association relationship (including newly happened association and newly happened dissociation) to the LMF, the corresponding steps are shown in FIG. 4 and summarized below.

FIG. 4 is a diagram illustrating an exemplary procedure for positioning a target by using multiple terminal devices according to an embodiment of the present disclosure. The procedure may begin at step S405 where a primary UE 100-1 may obtain an association with one or more other UEs/devices 100-2 that are all associated with a target 400. To be specific, a group/association may be established, formed, or otherwise obtained for at least two devices/UEs (e.g., the primary UE 100-1 and the other UEs/devices 100-2). In some embodiments, the group/association may be formed by the multiple devices/UEs themselves at step S405a. In some other embodiments, the association may be configured from the LMF 125 to the multiple UEs/devices at S405b. In this case, the LMF 125 may configure the association to any of the multiple devices/UEs. For example, the LMF 125 may configure the association to the primary UE 100-1 such that the primary UE 100-1 may form the association with other UEs/devices 100-2. For another example, when there is no primary UE in the multiple UEs/devices, the LMF 125 may configure the association to one or more of the multiple UEs directly, such that the multiple UEs may form the association without a primary UE involved.

For example, the target 400 may carry the primary UE 100-1 and the other UEs/devices 100-2. For another example, the target 400 and the primary UE 100-1 and the other UEs/devices 100-2 are all placed within a same container and moving together. In some embodiments, the association may be formed via Sidelink, Bluetooth, Wi-Fi, etc.

At step S410, the primary UE 100-1 may perform a group registration with the AMF 110. In some embodiments, IMSI/SUPI (Subscription Permanent Identifier) of each device may be included in the request for group registration.

At steps S415 and S420, the AMF 110 may verify the group registration (e.g., multiple subscriptions) with the UDM 405.

At step S425, upon successful verification of subscription, the AMF 110 may return temporary identifiers to the primary UE 100-1 for each device in the group/association. In some embodiments, a common group ID may also be assigned.

At steps S435, a procedure for positioning the target 400 may be initiated by the primary UE 100-1. In some embodiments, the initiation of the procedure may be trigged by a request for positioning received from one or more other UEs/devices 100-2 at optional step S430. In some other embodiments, the initiation of the procedure may be triggered by the primary UE 100-1 itself or by other network nodes, such as an LCS client or AF.

At step S440, the primary UE may use the ID obtained from the AMF 110 in LCS procedure to notify the LMF 125 of the multi-device positioning capability. In some embodiments, the capability can be reported via an LPP message embedded in LCS procedure. In some embodiments, the AMF 110 can verify the mobile originated location service request for multi-device positioning before forwarding it to LMF 125 (i.e., inform that multi-device positioning capability/subscription is checked at AMF 110 and inform/indicate LMF 125 that multi device positioning is possible along with the service request to LMF 125). Note: The positioning request may originate from one of the devices; and it can be initiated towards the network by the primary UE 100-1.

At step S445, the LMF 125, if decided to pursue multi-device positioning, can configure multiple measurements; (i.e., device-specific or same measurements required from multiple devices), depending on the capabilities of the multiple devices that include the primary UE 100-1 and one or more other device(s) 100-2.

At step S450a and S450b, the multiple UEs/devices in the association/group may perform measurements based on the received configurations.

At step S455, the primary UE 100-1 may obtain the measurement results from other device(s) 100-2 and provide the original measurement results or syncretized measurement results to LMF 125.

At step S460, the LMF 125 may fuse/combine the received measurements together to position the target 400 with an improved accuracy and/or integrity.

At step S465, the LMF 125 may provide the positioning result to the multiple UEs/devices 100-1 and 100-2.

In some embodiments, it is possible that the primary UE may also use the measurements for UE-Based positioning.

In some embodiments, to enable the LMF 125 and the primary UE 100-1 to exchange capabilities and measurement for the UEs associated in a group via LPP, the LPP IEs may be extended to support request and provide information of a UE group. The extensions are marked with track changes below.

An exemplary ASN. 1 is provided below where UE reports a number of associated devices and capability of each device.

| | |
|---|---|
| - | ProvideCapabilities |

The ProvideCapabilities message body in a LPP message indicates the LPP capabilities of the target
device to the location server.
-- ASN1START
ProvideCapabilities ::= SEQUENCE {

| criticalExtensions | | CHOICE { |
|---|---|---|
| | c1 | CHOICE { |

| | |
|---|---|
| provideCapabilities-r9 | ProvideCapabilities-r9-IEs, |

| spare2 NULL, spare1 NULL | |
|---|---|
| }, | |
| criticalExtensionsFuture | SEQUENCE { } |

}
}
ProvideCapabilities-r9-IEs ::= SEQUENCE {

| | | |
|---|---|---|
| commonIEsProvideCapabilities | CommonIEsProvideCapabilities | OPTIONAL, |
| a-gnss-ProvideCapabilities | A-GNSS-ProvideCapabilities | OPTIONAL, |
| otdoa-ProvideCapabilities | OTDOA-ProvideCapabilities | OPTIONAL, |
| ecid-ProvideCapabilities | ECID-ProvideCapabilities | OPTIONAL, |
| epdu-ProvideCapabilities | EPDU-Sequence | OPTIONAL, |

...,

| | | | |
|---|---|---|---|
| [[ | sensor-ProvideCapabilities-r13 | Sensor-ProvideCapabilities-r13 | OPTIONAL, |
| | tbs-ProvideCapabilities-r13 | TBS-ProvideCapabilities-r13 | OPTIONAL, |
| | wlan-ProvideCapabilities-r13 | WLAN-ProvideCapabilities-r13 | OPTIONAL, |
| | bt-ProvideCapabilities-r13 | BT-ProvideCapabilities-r13 | OPTIONAL |

]],

| [[ | nr-ECID-ProvideCapabilities-r16 | NR-ECID-ProvideCapabilities-r16 | OPTIONAL, |
|---|---|---|---|
| | nr-Multi-RTT-ProvideCapabilities-r16 | | |
| | | NR-Multi-RTT-ProvideCapabilities-r16 | OPTIONAL, |
| | nr-DL-AoD-ProvideCapabilities-r16 | | |
| | | NR-DL-AoD-ProvideCapabilities-r16 | OPTIONAL, |
| | nr-DL-TDOA-ProvideCapabilities-r16 | | |
| | | NR-DL-TDOA-ProvideCapabilities-r16 | OPTIONAL, |
| | nr-UL-ProvideCapabilities-r16 | NR-UL-ProvideCapabilities-r16 | OPTIONAL |

```
  ]],
  [[
```

| | |
|---|---|
| provideUEGroupCapabilities-rxx | ProvideUEGroupCapabilities-rxx |

]]
}
ProvideUEGroupCapabilities-rxx ::= SEQUENCE {

| nrOfassociatedDevices | INTEGER(2..N), |
|---|---|
| provideGroup-UECapablities-List | SEQUENCE (SIZE (1..maxNOfAssociatedDevices)) OF |
| | ProvideCapabilities-r9-IEs |

}
-- ASN1STOP

An exemplary ASN. 1 is provided below where UE reports multi device positioning measurement; at least one measurement per device.

| | |
|---|---|
| - | ProvideLocationInformation |

The ProvideLocationInformation message body in a LPP message is used by the target device to
provide positioning measurements or position estimates to the location server.
-- ASN1START
ProvideLocationInformation ::= SEQUENCE {

| criticalExtensions | | CHOICE { |
|---|---|---|
| | c1 | CHOICE { |

| | |
|---|---|
| provideLocationInformation-r9 | ProvideLocationInformation-r9-IEs, |

| spare3 NULL, spare2 NULL, spare1 NULL | |
|---|---|
| }, | |
| criticalExtensionsFuture | SEQUENCE { } |

```
  }
}
ProvideLocationInformation-r9-IEs ::= SEQUENCE {
  commonIEsProvideLocationInformation
```

| | CommonIEsProvideLocationInformation | OPTIONAL, |
|---|---|---|
| a-gnss-ProvideLocationInformation | A-GNSS-ProvideLocationInformation | OPTIONAL, |
| otdoa-ProvideLocationInformation | OTDOA-ProvideLocationInformation | OPTIONAL, |
| ecid-ProvideLocationInformation | ECID-ProvideLocationInformation | OPTIONAL, |
| epdu-ProvideLocation Information | EPDU-Sequence | OPTIONAL, |

```
  ...,
  [[
  sensor-ProvideLocationInformation-r13
```

| | Sensor-ProvideLocationInformation-r13 | |
|---|---|---|
| | | OPTIONAL, |
| tbs-ProvideLocationInformation-r13 | TBS-ProvideLocationInformation-r13 | OPTIONAL, |
| wlan-ProvideLocationInformation-r13 | WLAN-ProvideLocationInformation-r13 | OPTIONAL, |
| bt-ProvideLocationInformation-r13 | BT-ProvideLocationInformation-r13 | OPTIONAL |

]],

| | |
|---|---|
| [[ | nr-ECID-ProvideLocationInformation-r16 |

| | |
|---|---|
| NR-ECID-ProvideLocation Information-r16 | OPTIONAL, |

nr-Multi-RTT-ProvideLocationInformation-r16

| | |
|---|---|
| NR-Multi-RTT-ProvideLocationInformation-r16 | OPTIONAL, |

nr-DL-AoD-ProvideLocationInformation-r16

| | |
|---|---|
| NR-DL-AoD-ProvideLocationInformation-r16 | OPTIONAL, |

nr-DL-TDOA-ProvideLocationInformation-r16

| | |
|---|---|
| NR-DL-TDOA-ProvideLocationInformation-r16 | OPTIONAL |

```
  ]],
  [[
```

| | |
|---|---|
| provideUEGroupLocationInfo-rxx | ProvideUEGroupLocationInfo-rxx |

]]
}
ProvideUEGroupLocationInfo-rxx :: = SEQUENCE {

| | |
|---|---|
| multiDeviceMeasurementResult | MultiDeviceMeasurementResult |

}
-- ASN1STOP

MultiDeviceMeasurementResult ::= SEQUENCE {

| | |
|---|---|
| rstd-ResultList | SEQUENCE (SIZE (1..maxNOfAssociatedDevices)) OF |
| | RSTD |
| displacementSensor | SEQUENCE (SIZE (1..maxNOfAssociatedDevices)) OF |
| | Displacement |
| biometerPressureSensor | SEQUENCE (SIZE (1..maxNOfAssociatedDevices)) OF |
| | BarometerPressureSensor |

}

In some embodiments, the above measurement reporting can be also integrated as below.

NR-DL-TDOA-MeasElement-r16 ::= SEQUENCE {

| dl-PRS-ID-r16 | INTEGER (0..255), | |
|---|---|---|
| nr-PhysCellID-r16 | NR-PhysCellID-r16 | OPTIONAL, |
| nr-CellGlobalID-r16 | NCGI-r15 | OPTIONAL, |
| nr-ARFCN-r16 | ARFCN-ValueNR-r15 | OPTIONAL, |
| nr-DL-PRS-ResourceID-r16 | NR-DL-PRS-ResourceID-r16 | OPTIONAL, |
| nr-DL-PRS-ResourceSetID-r16 | NR-DL-PRS-ResourceSetID-r16 | OPTIONAL, |

| | |
|---|---|
| nr-TimeStamp-r16 | NR-TimeStamp-r16, |
| nr-RSTD-r16 | CHOICE { |

| | |
|---|---|
| k0-r16 | INTEGER (0..1970049), |
| k1-r16 | INTEGER (0..985025), |
| k2-r16 | INTEGER (0..492513), |
| k3-r16 | INTEGER (0..246257), |
| k4-r16 | INTEGER (0..123129), |
| k5-r16 | INTEGER (0..61565), |

...

},

| nr-AdditionalPathList-r16 | NR-AdditionalPathList-r16 | OPTIONAL, |
|---|---|---|
| nr-TimingQuality-r16 | NR-TimingQuality-r16, | |
| nr-DL-PRS-RSRP-Result-r16 | INTEGER (0..126) | OPTIONAL, |

nr-DL-TDOA-AdditionalMeasurements-r16

| | |
|---|---|
| NR-DL-TDOA-AdditionalMeasurements-r16 | OPTIONAL, |

```
  ...,
  [[
```

| | | |
|---|---|---|
| nr-UE-Rx-TEG-ID-r17 | INTEGER (0..maxNumOfRxTEGs-1-r17) | OPTIONAL, |
| nr-DL-PRS-FirstPathRSRP-Result-r17 | INTEGER (0..126) | OPTIONAL, |

| nr-los-nlos-Indicator-r17 | | CHOICE { |
|---|---|---|
| | perTRP-r17 | LOS-NLOS-Indicator-r17, |
| | perResource-r17 | LOS-NLOS-Indicator-r17 |

| } | | OPTIONAL, |
|---|---|---|
| nr-AdditionalPathListExt-r17 | NR-AdditionalPathListExt-r17 | OPTIONAL, |

nr-DL-TDOA-AdditionalMeasurementsExt-r17

| | |
|---|---|
| NR-DL-TDOA-AdditionalMeasurementsExt-r17 | OPTIONAL |

```
  ]],
  [[
```

| | |
|---|---|
| rstd-ResultList | SEQUENCE (SIZE (1..maxNOfAssociatedDevices)) OF |

RSTD

]]
RSTD ::= SEQUENCE {

| | |
|---|---|
| nr-RSTD-r16 | CHOICE { |

| | |
|---|---|
| k0-r16 | INTEGER (0..1970049), |
| k1-r16 | INTEGER (0..985025), |
| k2-r16 | INTEGER (0..492513), |
| k3-r16 | INTEGER (0..246257), |
| k4-r16 | INTEGER (0..123129), |
| k5-r16 | INTEGER (0..61565), |

| | |
|---|---|
| } | ... |

}

With some embodiments of the present disclosure, a more accurate positioning with a higher integrity can be achieved. For example, when positioning estimates are needed by a mobile phone and the phone is connected via sidelink/Bluetooth to other sensors such as watch or wearables which produce even better IMU results (for instance) when compared to the phone. In such case, it is possible to exploit the measurements from multiple devices including the phone, the watch, and/or the wearables.

Further, with some embodiments of the present disclosure, association with the primary phone can be made for other auxiliary devices. The association and different positioning capabilities can be informed to LMF (also known as, location server). The location server can assign different or same measurement requirements to associated devices and fuse the obtained measurement results to improve positioning accuracy and integrity.

Further, with some embodiments of the present disclosure, a simultaneous localization and mapping (SLAM) can be enabled.

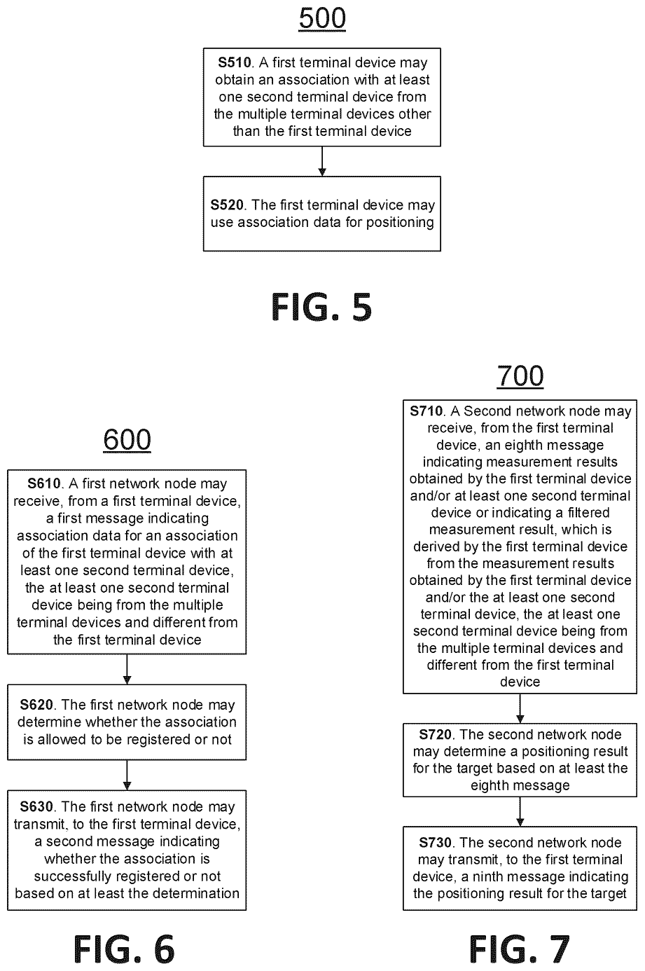

FIG. 5 is a flow chart of an exemplary method 500 at a first terminal device for positioning a target that is associated with multiple terminal devices comprising the first terminal device according to an embodiment of the present disclosure. The method 500 may be performed at a terminal device (e.g., the UE 100 shown in FIG. 1, the primary UE 100-1 and other UEs 100-2 shown in FIG. 4). The method 500 may comprise step S510 and Step S520. However, the present disclosure is not limited thereto. In some other embodiments, the method 500 may comprise more steps, less steps, different steps, or any combination thereof. Further the steps of the method 500 may be performed in a different order than that described herein. Further, in some embodiments, a step in the method 500 may be split into multiple sub-steps and performed by different entities, and/or multiple steps in the method 500 may be combined into a single step.

The method 500 may begin at step S510 where the first terminal device may obtain an association with at least one second terminal device from the multiple terminal devices other than the first terminal device.

At step S520, the first terminal device may use association data for positioning.

In some embodiments, the method 500 may further comprise: transmitting, to a first network node, a first message indicating the association data. In some embodiments, the method 500 may further comprise: receiving, from the first network node, a second message indicating whether the association is successfully registered or not. In some embodiments, the association data may indicate at least a common ID for the association. In some embodiments, the first terminal device may comprise a primary terminal device. In some embodiments, the first message may indicate at least one of: an identifier associated with the first terminal device; an identifier associated with at least one or each of the at least one second terminal device; a common identifier preconfigured for the association; and an indicator indicating that the first terminal device and the at least one second terminal device are associated for positioning.

In some embodiments, the second message may further indicate at least one of: a temporary identifier assigned to the first terminal device; a temporary identifier assigned to each of the at least one second terminal device; and a common identifier assigned to the association. In some embodiments, the step of obtaining the association may comprise: trying, for one or more rounds, to associate the first terminal device with at least one of the multiple terminal devices based on one or more factors, which are obtained by at least one of: a pre-configuration at the first terminal device and a dynamic configuration provided from a network node. In some embodiments, the one or more factors may comprise at least one of: an identifier associated with the first terminal device; an identifier associated with at least one of the at least one second terminal device; an indicator indicating which one of the first terminal device and/or the at least one second terminal device is a primary terminal device; an identifier associated with the association; a number of terminal devices in the association that are actually needed for positioning the target; an order in which the first terminal device tries to associate itself with the at least one second terminal device; whether the members in the association have a same ownership; whether the members in the association have a same synchronization reference source; whether the members in the association have same group communication; whether the members in the association have registrations to a same list; whether the members in the association have sign-ins under a same identifier; whether the members in the association have a same associated positioning request or measurement request; whether the members in the association have a same associated positioning result; whether the members in the association are quasi-collocated (QCL); and whether the members in the association have a common timing-related group; whether the members in the association have a common ID associated with the association; whether the members in the association have, for at least one radio measurement type, related measurement results that are close to each other to an extent defined by one or more thresholds; whether the members in the association have a same user or same carrier at the time of obtaining the association. In some embodiments, the step of trying may be performed for the multiple terminal devices one by one in the order indicated by the one or more factors until either the number indicated by the one or more factors is reached or associations with all of the multiple terminal devices have been tried.

In some embodiments, the method 500 may further comprise: in response to receiving the second message, transmitting, to the at least one second terminal device, a message indicating at least one content indicated by the second message to trigger the at least one second terminal device to report their positioning capabilities. In some embodiments, the method 500 may further comprise: in response to determining that the association is successfully registered, transmitting, to a second network node, a third message indicating positioning capabilities of the first terminal device or positioning capabilities of both the first terminal device and the at least one second terminal device; and receiving, from the second network node, a fourth message indicating positioning configurations for the first terminal device or positioning configurations for both the first terminal device and the at least one second terminal device and/or a measurement request. In some embodiments, the positioning configuration may comprise at least one of: a configuration for radio signals to be received for positioning; a configuration for radio signals to be transmitted for positioning; and a configuration for positioning measurement.

In some embodiments, the third message may indicate at least one of: a temporary identifier assigned to the first terminal device; a temporary identifier assigned to each of the at least one second terminal device; a common identifier assigned to the association; a number of terminal devices that are associated with each other for positioning; and a list of capabilities, one for each of the terminal devices that are associated with each other for positioning. In some embodiments, when the fourth message indicates one or more positioning configurations for the first terminal device and the at least one second terminal device, the method 500 may further comprise: transmitting, to the at least one second terminal device, a fifth message indicating the at least one positioning configuration for the at least one second terminal device, respectively, in response to receiving the fourth message.

In some embodiments, the third message may be transmitted to the second network node and the fourth message may be received from the second network node without involving any of the at least one second terminal device, or the third message may be transmitted to the second network node and the fourth message may be received from the second network node via one or more of the at least one second terminal device. In some embodiments, the method 500 may further comprise at least one of: performing one or more measurement related operations for positioning the target based on at least the positioning configuration for the first terminal device; transmitting, to one of the at least one second terminal device, a sixth message indicating one or more measurement results obtained by the first terminal device for positioning the target; and receiving, from the at least one second terminal device, a sixth message indicating one or more measurement results obtained by the at least one second terminal device for positioning the target.

In some embodiments, before the step of transmitting the third message, the method 500 may further comprise: receiving, from one of the at least one second terminal device, a seventh message for requesting positioning the target, the step of transmitting the third message may be performed in response to receiving the seventh message. In some embodiments, the method 500 may further comprise: transmitting, to the second network node, an eighth message indicating measurement results obtained by the first terminal device and/or the at least one second terminal device or indicating a filtered measurement result, which is derived by the first terminal device from the measurement results obtained by the first terminal device and/or the at least one second terminal device; and receiving, from the second network node, a ninth message indicating a positioning result for the target. In some embodiments, the eighth message may be transmitted to the second network node and the ninth message may be received from the second network node without involving any of the at least one second terminal device, or the eighth message may be transmitted to the second network node and the ninth message may be received from the second network node via one or more of the at least one second terminal device. In some embodiments, the measurement results indicated by the eighth message may comprise at least one of: a list of one or more measurement results for ToA; and a list of one or more measurement results for RSTD.

In some embodiments, the common identifier assigned to the association may be at least one of: an identifier identifying the association; an identifier identifying the first terminal device; an identifier identifying one of the at least one second terminal device; an identifier identifying the target; and a collection of multiple identifiers associated with multiple terminal devices that are associated with a same target and be able to perform different measurements for positioning. In some embodiments, the collection of multiple identifiers may comprise at least one of: a TMSI associated with the first terminal device; at least one TMSI associated with the at least one second terminal device; a Layer 2 Sidelink identifier associated with the first terminal device; at least one Layer 2 Sidelink identifier associated with the at least one second terminal device; a Bluetooth identifier associated with the first terminal device; at least one Bluetooth identifier associated with the at least one second terminal device; a Wi-Fi identifier associated with the first terminal device; and a Wi-Fi identifier associated with the at least one second terminal device.

In some embodiments, the first terminal device may be a primary terminal device for the association. In some embodiments, the first terminal device may be determined as the primary terminal device by at least one of: a pre-configuration; a dynamic configuration; and a selection based on one or more pre-defined rules. In some embodiments, the one or more pre-defined rules may comprise at least one of: the primary terminal device has the minimum capability defined for a primary terminal device; the primary terminal device has its PCell in a specific carrier frequency or frequency range; the primary terminal device is able to communicate with a communications network for performing a positioning service; the primary terminal device belongs to a power class defined for a primary terminal device; the primary terminal device has the strongest RSRP within the association; the primary terminal device has its RSRP at least above a threshold; the primary terminal device has a LOS path to a RAN node comprised in a communications network; the primary terminal device has the shortest timing measurement with respect to a communications network in the association; and the primary terminal device is not a RedCap terminal device. In some embodiments, the primary terminal device may be able to perform at least one of: acting on behalf of the association towards nodes external to the association; performing at least one radio measurement configured for the association; transmitting at least one radio signal configured for the association; reporting radio measurements on behalf of the association; receiving a request for one or more radio measurements to be performed by the members in the association on behalf of the members in the association; forwarding assistance data to the at least one second terminal device; triggering the at least one second terminal device to perform positioning measurements; collecting radio measurements from the at least one second terminal device; acting as a synchronization reference to the at least one second terminal device; providing another node external to the association with information about the association; and informing another node external to the association about a change in the association.

In some embodiments, a location of the primary terminal device may be used as a reference location for the at least one second terminal device. In some embodiments, the primary terminal device may be a QCL reference for the at least one second terminal device. In some embodiments, the method 500 may further comprise at least one of: associating with a new terminal device to let the new terminal device join the association; detecting the need of initiating a new round of association establishment; reporting, to the first network node, the information about the updated association once a new terminal device has joined the association; detecting that a terminal device leaves the association; and reporting, to the first network node, the information about the updated association once a terminal device leaves the association. In some embodiments, the first network node may be an AMF or an LMF, and/or the second network node may be an LMF.

In some embodiments, the method 500 may further comprise at least one of: transmitting, from the first terminal device to one of the at least one second terminal device, a sixth message indicating one or more measurement results obtained by the first terminal device for positioning the target, if the measurement-related operation performed by the first terminal device is to receive and measure a positioning-related reference signal (but is not to transmit a SRS) and if the mentioned one of the at least one second terminal device is the only terminal device that will be fully responsible for feedbacking positioning-related downlink measurement results to the network side, and transmitting from one of the at least one second terminal device, to the first terminal device or another one of the at least one second terminal device, a sixth message indicating one or more measurement results obtained by the at least one second terminal device for positioning the target, if the measurement-related operation performed by the at least one second terminal device is to receive and measure a positioning-related reference signal and if the first terminal device or the mentioned another one of the at least one second terminal device is the only UE that will be fully responsible for feedbacking positioning-related downlink measurement results to the network side.

In some embodiments, the method 500 may further comprise at least one of: receiving at the first terminal device, from each of the at least one second terminal device, a sixth message indicating one or more measurement results obtained by the mentioned second terminal device for positioning the target, if the measurement-related operation performed by the mentioned second terminal device is to receive and measure a positioning-related reference signal and if the first terminal device is the only UE that will be fully responsible for feedbacking positioning-related downlink measurement results to the network side, and receiving at one of the at least one second terminal device, from each of the first terminal device and all other second terminal devices, a sixth message indicating one or more measurement results obtained by one of the first terminal device and all other second terminal devices for positioning the target, if the measurement-related operation performed by each of the first terminal device and all other second terminal devices is to receive and measure a positioning-related reference signal and if the mentioned one of the at least one second terminal device is the only UE that will be fully responsible for feedbacking positioning-related downlink measurement results to the network side.

In some embodiments, the method 500 may further comprise at least one of: transmitting from the first terminal device, to the second network node, an eighth message indicating measurement results measured by the first terminal device, if the measurement-related operation performed by the first terminal device is to receive and measure a positioning-related reference signal (but is not to transmit a SRS) and if there is not a UE that will be fully responsible for feedbacking positioning-related downlink measurement results to the network side; transmitting from the first terminal device, to the second network node, an eighth message indicating filtered measurement results which is derived by the first terminal device upon the measurement results measured by the first terminal device and the at least one second terminal device, if the measurement-related operation performed by the first terminal device and the at least one second terminal device is to receive and measure a positioning-related reference signal and if the first terminal device is the only UE that will be fully responsible for feedbacking positioning-related downlink measurement results to the network side; transmitting from one of the at least one second terminal device, to the second network node, an eighth message indicating measurement results measured by the mentioned second terminal device, if the measurement-related operation performed by the mentioned second terminal device is to receive and measure a positioning-related reference signal and if there is not a UE that will be fully responsible for feedbacking positioning-related downlink measurement results to the network side; transmitting from one of the at least one second terminal device, to the second network node, an eighth message indicating filtered measurement results which is derived by the mentioned second terminal device upon the measurement results measured by the at least one second terminal device and the first terminal device, if the measurement-related operation performed by the at least one second terminal device and the first terminal device is to receive and measure a positioning-related reference signal and if the mentioned second terminal device is the only UE that will be fully responsible for feedbacking positioning-related downlink measurement results to the network side.

In some embodiments, the method 500 may further comprise receiving, at one of or all of the first terminal device and the at least one second terminal device, a ninth message indicating a positioning result for the target. In some embodiments, the measurement results indicated by the eighth message may comprise at least one of: a list of one or more displacement based measurement results; and a list of one or more barometric pressure sensor based measurement results.

In some embodiments, the primary terminal device may be able to perform at least one of: configuring other members in the first association; maintaining a list of members in the first association; verifying whether a member in the first association still meets a condition for being in the first association; informing a network node about a status of the first association; acting towards at least one other node on behalf of members in the first association; relaying data between at least one member in the first association and a node external to the first association; distributing or forwarding, to members in the first association, at least some of the data and/or information and/or configuration received from a network node; obtaining resources for the first association; configuring complementary resources for individual members in the first association; obtaining and/or determining and/or reporting a combined measurement result to a network node based on results of complementary operations of members in the first association; being or providing a synchronization reference for other members in the first association; collecting radio measurements within the first association; forwarding or sending assistance data to members in the first association; triggering members in the first association to perform at least one positioning measurement; comprising a Service Client for the first association if the Service Client resides in the terminal device side; and performing resource coordination or allocation among members in the first association.

FIG. 6 is a flow chart of an exemplary method 600 at a first network node for facilitating a first terminal device in positioning a target that is associated with multiple terminal devices comprising the first terminal device according to an embodiment of the present disclosure. The method 600 may be performed at a network node (e.g., the AMF 110 or the LMF 125 shown in FIG. 1). The method 600 may comprise step S610, S620, and Step S630. However, the present disclosure is not limited thereto. In some other embodiments, the method 600 may comprise more steps, less steps, different steps, or any combination thereof. Further the steps of the method 600 may be performed in a different order than that described herein. Further, in some embodiments, a step in the method 600 may be split into multiple sub-steps and performed by different entities, and/or multiple steps in the method 600 may be combined into a single step.

The method 600 may begin at step S610 where the first network node may receive, from the first terminal device, a first message indicating association data for an association of the first terminal device with at least one second terminal device, the at least one second terminal device being from the multiple terminal devices and different from the first terminal device.

At step S620, the first network node may determine whether the association is allowed to be registered or not.

At step S630, the first network node may transmit, to the first terminal device, a second message indicating whether the association is successfully registered or not based on at least the determination.

In some embodiments, the association data may indicate at least a common identifier (ID) for the association. In some embodiments, the first terminal device may comprise a primary terminal device. In some embodiments, the first message may indicate at least one of: an identifier associated with the first terminal device; an identifier associated with at least one or each of the at least one second terminal device; a common identifier preconfigured for the association; and an indicator indicating that the first terminal device and the at least one second terminal device are associated for positioning. In some embodiments, the second message may further indicate at least one of: a temporary identifier assigned to the first terminal device; a temporary identifier assigned to each of the at least one second terminal device; and a common identifier assigned to the association. In some embodiments, the method 600 may further comprise: transmitting, to the first terminal device, a message indicating one or more factors used for selecting one or more terminal devices to be associated with the first terminal device. In some embodiments, the one or more factors may comprise at least one of: an identifier associated with the first terminal device; an identifier associated with at least one of the at least one second terminal device; an indicator indicating which one of the first terminal device and/or the at least one second terminal device is a primary terminal device; an identifier associated with the association; a number of terminal devices in the association that are actually needed for positioning the target; an order in which the first terminal device tries to associate itself with the at least one second terminal device; whether the members in the association have a same ownership; whether the members in the association have a same synchronization reference source; whether the members in the association have same group communication; whether the members in the association have registrations to a same list; whether the members in the association have sign-ins under a same identifier; whether the members in the association have a same associated positioning request or measurement request; whether the members in the association have a same associated positioning result; whether the members in the association are quasi-collocated (QCL); and whether the members in the association have a common timing-related group; whether the members in the association have a common ID associated with the association; whether the members in the association have, for at least one radio measurement type, related measurement results that are close to each other to an extent defined by one or more thresholds; whether the members in the association have a same user or same carrier at the time of obtaining the association.

In some embodiments, the first terminal device may be a primary terminal device for the association. In some embodiments, the method 600 may further comprise at least one of: receiving, from the first terminal device, a report indicating a join of a new terminal device into the association; and receiving, from the first terminal device, a report indicating a leave of a terminal device from the association. In some embodiments, the first network node may be an AMF and/or an LMF.

FIG. 7 is a flow chart of an exemplary method 700 at a second network node for facilitating a first terminal device in positioning a target that is associated with multiple terminal devices comprising the first terminal device according to an embodiment of the present disclosure. The method 700 may be performed at a network node (e.g., the LMF 125 shown in FIG. 1). The method 700 may comprise step S710, S720, and Step S730. However, the present disclosure is not limited thereto. In some other embodiments, the method 700 may comprise more steps, less steps, different steps, or any combination thereof. Further the steps of the method 700 may be performed in a different order than that described herein. Further, in some embodiments, a step in the method 700 may be split into multiple sub-steps and performed by different entities, and/or multiple steps in the method 700 may be combined into a single step.

The method 700 may begin at step S710 where the second network node may receive, from the first terminal device, an eighth message indicating measurement results obtained by the first terminal device and/or at least one second terminal device or indicating a filtered measurement result, which is derived by the first terminal device from the measurement results obtained by the first terminal device and/or the at least one second terminal device, the at least one second terminal device being from the multiple terminal devices and different from the first terminal device.

At step S720, the second network node may determine a positioning result for the target based on at least the eighth message.

At step S730, the second network node may transmit, to the first terminal device, a ninth message indicating the positioning result for the target.

In some embodiments, the eighth message may be received from the first terminal device and the ninth message is transmitted to the first terminal device without involving any of the at least one second terminal device, or the eighth message is received from the first terminal device and the ninth message is transmitted to the first terminal device via one or more of the at least one second terminal device. In some embodiments, the measurement results indicated by the eighth message may comprise at least one of: a list of one or more measurement results for ToA; and a list of one or more measurement results for RSTD. In some embodiments, before the step of receiving the eighth message, the method 700 may further comprise: receiving, from the first terminal device, a third message indicating positioning capabilities of the first terminal device or positioning capabilities of both the first terminal device and the at least one second terminal device; determining a positioning configuration for the first terminal device based on at least the positioning capabilities of the first terminal device or determining positioning configurations for both the first terminal device and the at least one second terminal device based on at least the positioning capabilities of both the first terminal device and the at least one second terminal device; and transmitting, to the first terminal device and/or the at least one second terminal device, a fourth message indicating the positioning configuration for the first terminal device or the positioning configurations for both the first terminal device and the at least one second terminal device and/or a measurement request. In some embodiments, the positioning configuration may comprise at least one of: a configuration for radio signals to be received for positioning; a configuration for radio signals to be transmitted for positioning; and a configuration for positioning measurement. In some embodiments, the third message may indicate at least one of: a temporary identifier assigned to the first terminal device; a temporary identifier assigned to each of the at least one second terminal device; a common identifier assigned to the association; a number of terminal devices that are associated with each other for positioning; and a list of capabilities, one for each of the terminal devices that are associated with each other for positioning.

In some embodiments, the third message may be received from the first terminal device and the fourth message may be transmitted to the first terminal device and/or the at least one second terminal device without involving any of the at least one second terminal device, or the third message may be received from the first terminal device and the fourth message may be transmitted to the first terminal device and/or the at least one second terminal device via one or more of the at least one second terminal device.

In some embodiments, the common identifier assigned to the association may be at least one of: an identifier identifying the association; an identifier identifying the first terminal device; an identifier identifying one of the at least one second terminal device; an identifier identifying the target; and a collection of multiple identifiers associated with multiple terminal devices that are associated with a same target and be able to perform different measurements for positioning. In some embodiments, the collection of multiple identifiers may comprise at least one of: a TMSI associated with the first terminal device; at least one TMSI associated with the at least one second terminal device; a Layer 2 Sidelink identifier associated with the first terminal device; at least one Layer 2 Sidelink identifier associated with the at least one second terminal device; a Bluetooth identifier associated with the first terminal device; at least one Bluetooth identifier associated with the at least one second terminal device; a Wi-Fi identifier associated with the first terminal device; and a Wi-Fi identifier associated with the at least one second terminal device.

In some embodiments, the first terminal device may be a primary terminal device for the association. In some embodiments, the method 700 may further comprise at least one of: receiving, from the first terminal device, the information about the updated association once a new terminal device has joined the association; and receiving, from the first terminal device, the information about the updated association once a terminal device leaves the association. In some embodiments, the second network node may be an LMF.

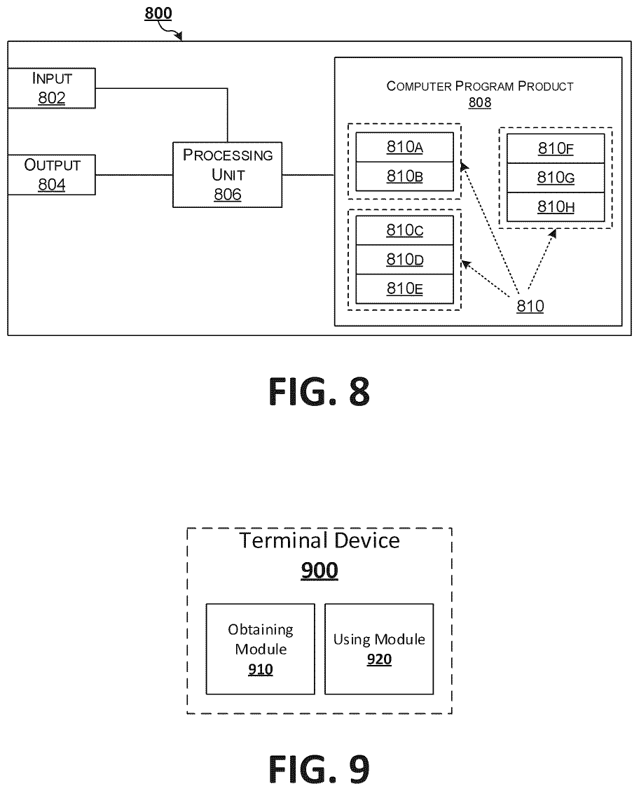

FIG. 8 schematically shows an embodiment of an arrangement which may be used in network nodes and/or a terminal device according to an embodiment of the present disclosure. Comprised in the arrangement 800 are a processing unit 806, e.g., with a Digital Signal Processor (DSP) or a Central Processing Unit (CPU). The processing unit 806 may be a single unit or a plurality of units to perform different actions of procedures described herein. The arrangement 800 may also comprise an input unit 802 for receiving signals from other entities, and an output unit 804 for providing signal(s) to other entities. The input unit 802 and the output unit 804 may be arranged as an integrated entity or as separate entities.

Furthermore, the arrangement 800 may comprise at least one computer program product 808 in the form of a non-volatile or volatile memory, e.g., an Electrically Erasable Programmable Read-Only Memory (EEPROM), a flash memory and/or a hard drive. The computer program product 808 comprises a computer program 810, which comprises code/computer readable instructions, which when executed by the processing unit 806 in the arrangement 800 causes the arrangement 800 and/or the network nodes and/or the terminal device in which it is comprised to perform the actions, e.g., of the procedure described earlier in conjunction with FIG. 2 through FIG. 7 or any other variant.

The computer program 810 may be configured as a computer program code structured in computer program modules 810A and 810B. Hence, in an exemplifying embodiment when the arrangement 800 is used in a first terminal device for positioning a target that is associated with multiple terminal devices comprising the first terminal device, the code in the computer program of the arrangement 800 includes: a module 810A configured to obtain an association with at least one second terminal device from the multiple terminal devices other than the first terminal device; and a module 810B configured to use association data for positioning.

Additionally or alternatively, the computer program 810 may be further configured as a computer program code structured in computer program modules 810C, 810D, and 810E. Hence, in an exemplifying embodiment when the arrangement 800 is used in a first network node for facilitating a first terminal device in positioning a target that is associated with multiple terminal devices comprising the first terminal device, the code in the computer program of the arrangement 800 includes: a module 810C configured to receive, from the first terminal device, a first message indicating association data for an association of the first terminal device with at least one second terminal device, the at least one second terminal device being from the multiple terminal devices and different from the first terminal device; a module 810D configured to determine whether the association is allowed to be registered or not; and a module 810E configured to transmit, to the first terminal device, a second message indicating whether the association is successfully registered or not based on at least the determination.

Additionally or alternatively, the computer program 810 may be further configured as a computer program code structured in computer program modules 810F, 810G, and 810H. Hence, in an exemplifying embodiment when the arrangement 800 is used in a second network node for facilitating a first terminal device in positioning a target that is associated with multiple terminal devices comprising the first terminal device, the code in the computer program of the arrangement 800 includes: a module 810F configured to receive, from the first terminal device, an eighth message indicating measurement results obtained by the first terminal device and/or at least one second terminal device or indicating a filtered measurement result, which is derived by the first terminal device from the measurement results obtained by the first terminal device and/or the at least one second terminal device, the at least one second terminal device being from the multiple terminal devices and different from the first terminal device; a module 810G configured to determine a positioning result for the target based on at least the eighth message; and a module 810H configured to transmit, to the first terminal device, a ninth message indicating the positioning result for the target.

The computer program modules could essentially perform the actions of the flow illustrated in FIG. 2 through FIG. 7, to emulate the terminal device and/or the network nodes. In other words, when the different computer program modules are executed in the processing unit 806, they may correspond to different modules in the network nodes and/or the terminal device.

Although the code means in the embodiments disclosed above in conjunction with FIG. 8 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the network nodes and/or terminal device.

Correspondingly to the method 500 as described above, an exemplary first terminal device for positioning a target that is associated with multiple terminal devices comprising the first terminal device is provided. FIG. 9 is a block diagram of an exemplary terminal device 900 according to an embodiment of the present disclosure. The terminal device 900 may be, e.g., the UE 100 or the primary UE 100-1 or other UEs/devices 100-2 in some embodiments.

The terminal device 900 may be configured to perform the method 500 as described above in connection with FIG. 5. As shown in FIG. 9, the terminal device 900 may comprise: an obtaining module 910 configured to obtain an association with at least one second terminal device from the multiple terminal devices other than the first terminal device; and a using module 920 configured to use association data for positioning.

The above modules 910 and/or 920 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 5. Further, the terminal device 900 may comprise one or more further modules, each of which may perform any of the steps of the method 500 described with reference to FIG. 5.

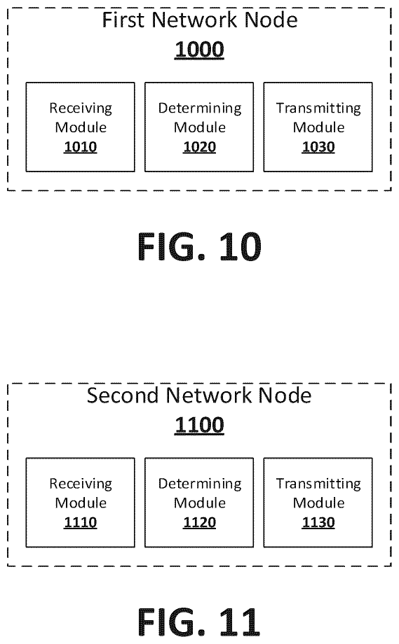

Correspondingly to the method 600 as described above, an exemplary first network node for facilitating a first terminal device in positioning a target that is associated with multiple terminal devices comprising the first terminal device is provided. FIG. 10 is a block diagram of an exemplary first network node 1000 according to an embodiment of the present disclosure. The first network node 1000 may be, e.g., the AMF 110 or the LMF 125 in some embodiments.

The first network node 1000 may be configured to perform the method 600 as described above in connection with FIG. 6. As shown in FIG. 10, the first network node 1000 may comprise: a receiving module 1010 configured to receive, from the first terminal device, a first message indicating association data for an association of the first terminal device with at least one second terminal device, the at least one second terminal device being from the multiple terminal devices and different from the first terminal device; a determining module 1020 configured to determine whether the association is allowed to be registered or not; and a transmitting module 1030 configured to transmit, to the first terminal device, a second message indicating whether the association is successfully registered or not based on at least the determination.

The above modules 1010, 1020, and/or 1030 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 6. Further, the first network node 1000 may comprise one or more further modules, each of which may perform any of the steps of the method 600 described with reference to FIG. 6.

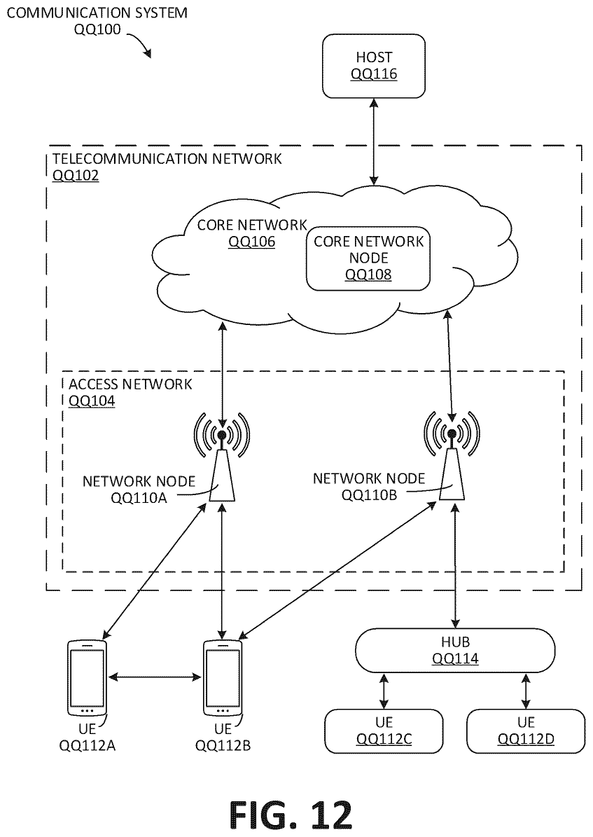

Correspondingly to the method 700 as described above, an exemplary second network node for facilitating a first terminal device in positioning a target that is associated with multiple terminal devices comprising the first terminal device is provided. FIG. 11 is a block diagram of an exemplary second network node 1100 according to an embodiment of the present disclosure. The second network node 1100 may be, e.g. the LMF 125 in some embodiments.

The second network node 1100 may be configured to perform the method 700 as described above in connection with FIG. 7. As shown in FIG. 11, the second network node 1100 may comprise: a receiving module 1110 configured to receive, from the first terminal device, an eighth message indicating measurement results obtained by the first terminal device and/or at least one second terminal device or indicating a filtered measurement result, which is derived by the first terminal device from the measurement results obtained by the first terminal device and/or the at least one second terminal device, the at least one second terminal device being from the multiple terminal devices and different from the first terminal device; a determining module 1120 configured to determine a positioning result for the target based on at least the eighth message; and a transmitting module 1130 configured to transmit, to the first terminal device, a ninth message indicating the positioning result for the target.

The above modules 1110, 1120, and/or 1130 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 7. Further, the second network node 1100 may comprise one or more further modules, each of which may perform any of the steps of the method 700 described with reference to FIG. 7.

FIG. 12 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

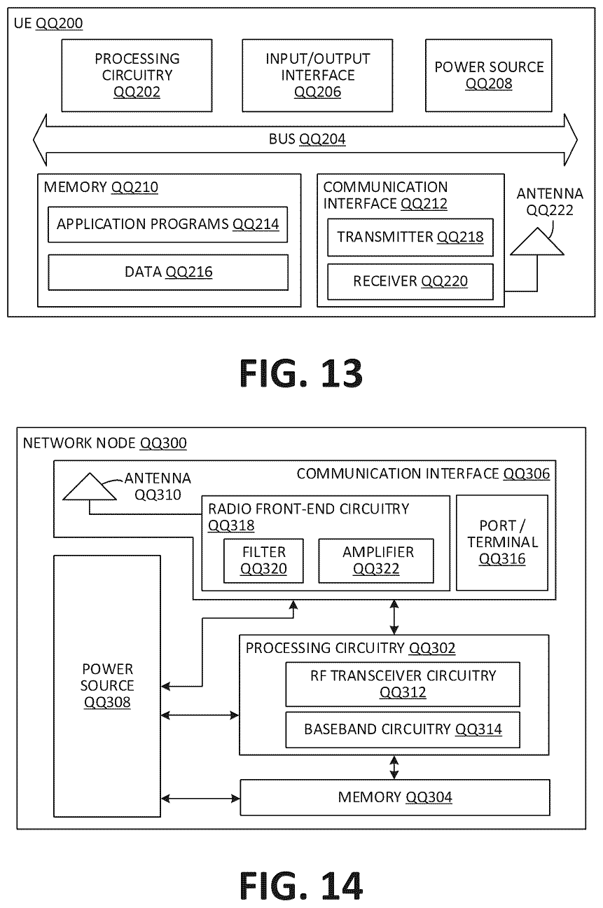

FIG. 13 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 13. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAS), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 13.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 14 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 14 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

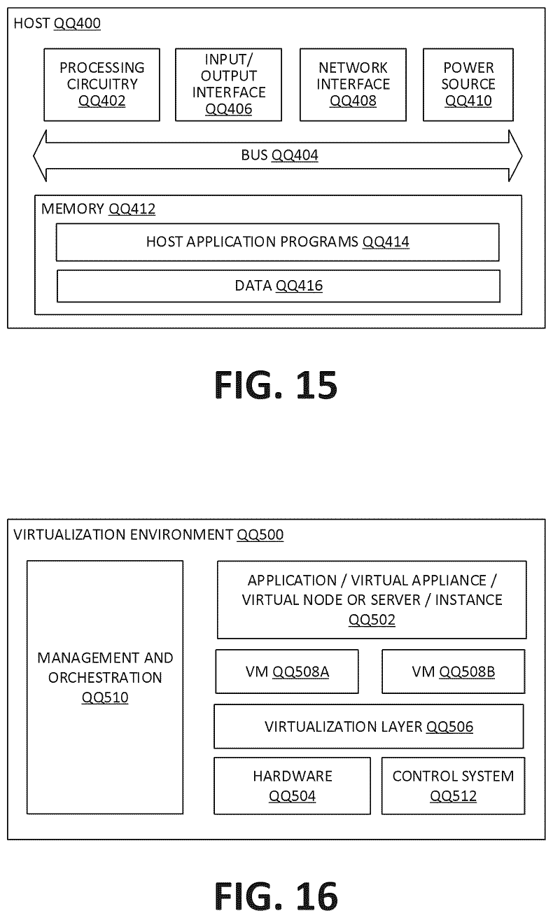

FIG. 15 is a block diagram of a host QQ400, which may be an embodiment of the host QQ116 of FIG. 12, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as FIG. 13 and FIG. 14, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 16 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment QQ500 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

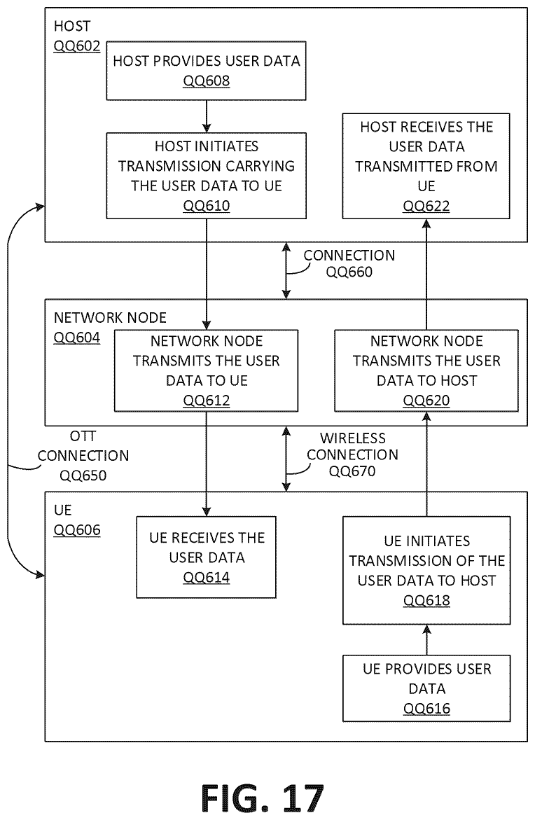

FIG. 17 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 12 and/or UE QQ200 of FIG. 13), network node (such as network node QQ110a of FIG. 12 and/or network node QQ300 of FIG. 14), and host (such as host QQ116 of FIG. 12 and/or host QQ400 of FIG. 15) discussed in the preceding paragraphs will now be described with reference to FIG. 17.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 12) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve the data rate, latency, power consumption and thereby provide benefits such as reduced user waiting time, relaxed restriction on file size, improved content resolution, better responsiveness, extended battery lifetime.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

| Abbreviation | Explanation |
|---|---|
| AoA | Angle of Arrival |
| L1, L2, L3 | Layer 1, Layer 2, Layer 3 |
| PRS | Positioning Reference Signal |
| PSS | Primary Synchronization Signal |
| RS | Reference Signal |
| RSRP | Reference Signal Received Power |
| RSRQ | Reference Signal Received Quality |
| RSSI | Received Signal Strength Indicator |
| RTOA | Relative Rime Of Arrival |
| RTT | Round Trip Time |
| SINR | Signal-to-Noise and Interference Ratio |
| SMTC | SSB Measurement Timing Configuration |
| SRS | Sounding Reference Signal |
| SSB | Synchronization Signal and PBCH Block |
| SSS | Secondary Synchronization Signal |
| TA | Timing Advance |
| TDOA | Time Difference Of Arrival |
| TOA | Time Of Arrival |
| TRP | Transmission and/or Reception Point |
| UE | User Equipment |

1. A method at a first terminal device for positioning a target that is associated with multiple terminal devices comprising the first terminal device, the method comprising:
obtaining an association with at least one second terminal device from the multiple terminal devices other than the first terminal device; and
using association data for positioning;
wherein the association data indicates at least a common identifier (ID) for the association.

2. The method of claim 1, further comprising:
transmitting, to a first network node, a first message indicating the association data; and/or
receiving, from the first network node, a second message indicating whether the association is successfully registered or not.

3-5. (canceled)

6. The method of claim 2, wherein the first message indicates at least one of:
an identifier associated with the first terminal device;
an identifier associated with at least one or each of the at least one second terminal device;
a common identifier preconfigured for the association; and
an indicator indicating that the first terminal device and the at least one second terminal device are associated for positioning;
and/or wherein the second message further indicates at least one of:
a temporary identifier assigned to the first terminal device;
a temporary identifier assigned to each of the at least one second terminal device; and
a common identifier assigned to the association.

7. (canceled)

8. The method of claim 1, wherein the step of obtaining the association comprises:
trying, for one or more rounds, to associate the first terminal device with at least one of the multiple terminal devices based on one or more factors, which are obtained by at least one of: a pre-configuration at the first terminal device and a dynamic configuration provided from a network node.

9. The method of claim 8, wherein the one or more factors comprise at least one of:
an identifier associated with the first terminal device;
an identifier associated with at least one of the at least one second terminal device;
an indicator indicating which one of the first terminal device and/or the at least one second terminal device is a primary terminal device;
an identifier associated with the association;
a number of terminal devices in the association that are actually needed for positioning the target;
an order in which the first terminal device tries to associate itself with the at least one second terminal device;
whether the members in the association have a same ownership;
whether the members in the association have a same synchronization reference source;
whether the members in the association have same group communication;
whether the members in the association have registrations to a same list;
whether the members in the association have sign-ins under a same identifier;
whether the members in the association have a same associated positioning request or measurement request;
whether the members in the association have a same associated positioning result;
whether the members in the association are quasi-collocated (QCL); and
whether the members in the association have a common timing-related group;
whether the members in the association have a common ID associated with the association;
whether the members in the association have, for at least one radio measurement type, related measurement results that are close to each other to an extent defined by one or more thresholds;
whether the members in the association have a same user or same carrier at the time of obtaining the association; and/or
wherein the step of trying is performed for the multiple terminal devices one by one in the order indicated by the one or more factors until either the number indicated by the one or more factors is reached or associations with all of the multiple terminal devices have been tried.

10. (canceled)

11. The method of claim 2, further comprising:
in response to receiving the second message,
transmitting, to the at least one second terminal device, a message indicating at least one content indicated by the second message to trigger the at least one second terminal device to report their positioning capabilities.

12. The method of claim 2, further comprising:
in response to determining that the association is successfully registered,
transmitting, to a second network node, a third message indicating positioning capabilities of the first terminal device or positioning capabilities of both the first terminal device and the at least one second terminal device; and
receiving, from the second network node, a fourth message indicating positioning configurations for the first terminal device or positioning configurations for both the first terminal device and the at least one second terminal device and/or a measurement request.

13. The method of claim 12, wherein the positioning configuration comprises at least one of:
a configuration for radio signals to be received for positioning;
a configuration for radio signals to be transmitted for positioning; and
a configuration for positioning measurement; or
wherein the third message indicates at least one of:
a temporary identifier assigned to the first terminal device;
a temporary identifier assigned to each of the at least one second terminal device;
a common identifier assigned to the association;
a number of terminal devices that are associated with each other for positioning; and
a list of capabilities, one for each of the terminal devices that are associated with each other for positioning.

14. (canceled)

15. The method of claim 12, wherein when the fourth message indicates one or more positioning configurations for the first terminal device and the at least one second terminal device, the method further comprises:
transmitting, to the at least one second terminal device, a fifth message indicating the at least one positioning configuration for the at least one second terminal device, respectively, in response to receiving the fourth message; and/or
wherein the third message is transmitted to the second network node and the fourth message is received from the second network node without involving any of the at least one second terminal device, or
the third message is transmitted to the second network node and the fourth message is received from the second network node via one or more of the at least one second terminal device.

16. (canceled)

17. The method of claim 12, further comprising at least one of:
performing one or more measurement related operations for positioning the target based on at least the positioning configuration for the first terminal device;
transmitting, to one of the at least one second terminal device, a sixth message indicating one or more measurement results obtained by the first terminal device for positioning the target; and
receiving, from the at least one second terminal device, a sixth message indicating one or more measurement results obtained by the at least one second terminal device for positioning the target.

18. The method of claim 12, wherein before the step of transmitting the third message, the method further comprises:
receiving, from one of the at least one second terminal device, a seventh message for requesting positioning the target,
wherein the step of transmitting the third message is performed in response to receiving the seventh message.

19. The method of claim 2, further comprising:
transmitting, to the second network node, an eighth message indicating measurement results obtained by the first terminal device and/or the at least one second terminal device or indicating a filtered measurement result, which is derived by the first terminal device from the measurement results obtained by the first terminal device and/or the at least one second terminal device; and
receiving, from the second network node, a ninth message indicating a positioning result for the target.

20. The method of claim 19, wherein the eighth message is transmitted to the second network node and the ninth message is received from the second network node without involving any of the at least one second terminal device, or
wherein the eighth message is transmitted to the second network node and the ninth message is received from the second network node via one or more of the at least one second terminal device; or
wherein the measurement results indicated by the eighth message comprise at least one of:
a list of one or more measurement results for Time of Arrival (ToA); and
a list of one or more measurement results for Reference Signal Time Difference (RSTD).

21. (canceled)

22. The method of claim 6, wherein the common identifier assigned to the association is at least one of:
an identifier identifying the association;
an identifier identifying the first terminal device;
an identifier identifying one of the at least one second terminal device;
an identifier identifying the target; and
a collection of multiple identifiers associated with multiple terminal devices that are associated with a same target and be able to perform different measurements for positioning.

23. The method of claim 22, wherein the collection of multiple identifiers comprises at least one of:
a Temporary Mobile Subscription Identifier (TMSI) associated with the first terminal device;
at least one TMSI associated with the at least one second terminal device;
a Layer 2 Sidelink identifier associated with the first terminal device;
at least one Layer 2 Sidelink identifier associated with the at least one second terminal device;
a Bluetooth identifier associated with the first terminal device;
at least one Bluetooth identifier associated with the at least one second terminal device;
a Wi-Fi identifier associated with the first terminal device; and
a Wi-Fi identifier associated with the at least one second terminal device.

24. The method of claim 1, wherein the first terminal device is a primary terminal device for the association; and
wherein the first terminal device is determined as the primary terminal device by at least one of:
a pre-configuration;
a dynamic configuration; and
a selection based on one or more pre-defined rules.

25. (canceled)

26. The method of claim 24, wherein the one or more pre-defined rules comprise at least one of:
the primary terminal device has the minimum capability defined for a primary terminal device;
the primary terminal device has its primary cell (PCell) in a specific carrier frequency or frequency range;
the primary terminal device is able to communicate with a communications network for performing a positioning service;
the primary terminal device belongs to a power class defined for a primary terminal device;
the primary terminal device has the strongest Reference Signal Received Power (RSRP) within the association;
the primary terminal device has its RSRP at least above a threshold;
the primary terminal device has a Line of Sight (LOS) path to a Radio Access Network (RAN) node comprised in a communications network;
the primary terminal device has the shortest timing measurement with respect to a communications network in the association; and
the primary terminal device is not a reduced capability (RedCap) terminal device; or
wherein the primary terminal device is able to perform at least one of:
acting on behalf of the association towards nodes external to the association;
performing at least one radio measurement configured for the association;
transmitting at least one radio signal configured for the association;
reporting radio measurements on behalf of the association;
receiving a request for one or more radio measurements to be performed by the members in the association on behalf of the members in the association;
forwarding assistance data to the at least one second terminal device;
triggering the at least one second terminal device to perform positioning measurements;
collecting radio measurements from the at least one second terminal device;
acting as a synchronization reference to the at least one second terminal device;
providing another node external to the association with information about the association; and
informing another node external to the association about a change in the association; or
wherein a location of the primary terminal device is used as a reference location for the at least one second terminal device; or
wherein the primary terminal device is a Quasi-Co-Location (QCL) reference for the at least one second terminal device.

27-29. (canceled)

30. The method of claim 24, further comprising at least one of:
associating with a new terminal device to let the new terminal device join the association;
detecting the need of initiating a new round of association establishment;
reporting, to the first network node, the information about the updated association once a new terminal device has joined the association;
detecting that a terminal device leaves the association; and
reporting, to the first network node, the information about the updated association once a terminal device leaves the association.

31. The method of claim 1, wherein the first network node is an Access and Mobility Management Function (AMF) or a Location Management Function (LMF), and/or
wherein the second network node is an LMF.

32. A terminal device, comprising:
a processor;
a memory storing instructions which, when executed by the processor, cause the processor to perform operations comprising:
obtain an association with at least one second terminal device from the multiple terminal devices other than the first terminal device; and
use association data for positioning;
wherein the association data indicates at least a common identifier (ID) for the association.

33-64. (canceled)
